(19) United States
(12) Patent Application Publication
(10) Pub. No.: US 2021/0262790 A1
(43) Pub. Date: Aug. 26, 2021

(54) Optical Axis Deviation Detecting Device, Target Detection Device, and Movable Body

(71) Applicant: Mitsubishi Electric Corporation, Chiyoda-ku, Tokyo (JP)

(72) Inventor: Sumitoshi KAWASAKI, Chiyoda-ku, Tokyo (JP)

(73) Assignee: Mitsubishi Electric Corporation, Chiyoda-ku, Tokyo (JP)

(21) Appl. No.: 17/271,879

(22) PCT Filed: Oct. 31, 2018
(86) PCT No.: PCT/JP2018/040529

§ 371 Date: Feb. 26, 2021

(51) Int. Cl. G01B 11/27; G01S 7/497; G01S 17/08

(52) U.S. Cl. CPC G01B 11/272; G01S 17/08; G01S 7/497

(57) ABSTRACT

An optical axis deviation detecting device includes a mirror to perform driving to change an output direction of output light, an adjustment mirror to reflect light output from the mirror and including a low reflection region and a high reflection region, a light receiver to receive light from the adjustment mirror, a non-deviation peak memory to store the amount of drive at which the amount of received light reaches a peak or an inverse peak based on reflection by the adjustment mirror when optical axis deviation is not occurring, a peak acquisition circuit to acquire the amount of drive at the time of a peak or an inverse peak of the amount of received light by driving of the mirror during an optical axis deviation detection mode, and a first deviation amount detector to detect an optical axis deviation based on the stored and acquired amounts of drive.

### TECHNICAL FIELD

The present invention relates to an optical axis deviation detecting device for detecting an optical axis deviation, a target detection device, and a movable body.

### BACKGROUND ART

Conventionally, a measurement device, mountable on a movable body (for example, a vehicle) capable of autonomous driving, to measure the distance between the movable body and a target is known. The measurement device emits laser light in a predetermined direction (for example, forward), receives reflected laser light returning from the target, and detects the distance to the target based on the reflected laser light. Such a measurement device need to accurately specify the optical axis direction of laser light.

Methods of detecting the amount of deviation from a reference direction of the optical axis have been proposed. For example, PTL 1 proposes a method of detecting the amount of deviation using a target board including two regions with different reflectances for output laser light.

### CITATION LIST

### Patent Literature

PTL 1: Japanese Patent Laying-Open No. 2001-59724

### SUMMARY OF INVENTION

### Technical Problem

Unfortunately, in the technique described in PTL 1, the user has to move a movable body to the place where the target board is installed. The technique described in PTL 1 therefore imposes a burden on the user.

The present invention is made in order to solve the problem described above and aims to provide an optical axis deviation detecting device capable of detecting an optical axis deviation without imposing a burden on the user.

### Solution to Problem

According to an aspect of the present invention, an optical axis deviation detecting device mountable on a movable body includes: an output unit to perform driving to change an output direction and output light; a reflective member including a first region and a second region having a lower reflectance of light than the first region, the reflective member reflecting light output from the output unit; a light receiver to receive light reflected by the reflective member; a memory to store beforehand at least one of information on an output direction in which the amount of received light by the light receiver reaches a peak based on reflection by the first region in a case where an optical axis deviation of the output unit is not occurring and information on an output direction in which the amount of received light by the light receiver reaches an inverse peak based on reflection of light by the second region in a case where an optical axis deviation of the output unit is not occurring; an acquisition circuit to acquire information on an output direction when the amount of received light by the light receiver reaches at least one of a peak and an inverse peak by performing driving of the output unit during detection of the optical axis deviation; and a detector to detect the optical axis deviation, based on the information on an output direction stored in the memory and the information on an output direction acquired by the acquisition circuit.

According to another aspect of the present invention, an optical axis deviation detecting device mountable on a movable body includes: an output unit to perform driving to change an output direction and output light; a light receiver to receive light output from the output unit and reflected by the movable body; an acquisition circuit to acquire outer shape information indicating a part of an outer shape of the movable body as a result of driving by the output circuit in a predetermined drive range during detection of the optical axis deviation of the output unit; a memory to store beforehand outer shape information indicating a part of an outer shape of the movable body acquired as a result of driving by the output circuit in the predetermined drive range in a case where the optical axis deviation is not occurring; and a detector to detect the optical axis deviation, based on the outer shape information stored in the memory and the outer shape information acquired by the acquisition circuit.

According to another aspect of the present invention, a target detection device mountable on a movable body includes the optical axis deviation detecting device. The light receiver receives light output from the output unit and reflected by a target present outside the movable body. The target detection device further includes a target detector to detect information on the target, based on the amount of received light by the light receiver.

According to another aspect of the present invention, a movable body including the target detection device is provided.

### Advantageous Effects of Invention

According to the present invention, an optical axis deviation detecting device capable of detecting an optical axis deviation without imposing a burden on the user is provided.

### BRIEF DESCRIPTION OF DRAWINGS

FIG. 1 is a diagram showing an example of a scene to which an optical axis deviation detecting device in the present embodiment is applied.

FIG. 2 is a diagram showing an example of a scene to which the optical axis deviation detecting device in the present embodiment is applied.

FIG. 3 is a diagram showing a movable body in the present embodiment.

FIG. 4 is a diagram showing a hardware configuration of the optical axis deviation detecting device in the present embodiment.

FIG. 5 is a diagram showing a configuration example of the movable body in the present embodiment.

FIG. 6 is a diagram showing a configuration example of the optical axis deviation detecting device in the present embodiment.

FIG. 7 is a diagram showing a reflection region of an adjustment mirror in the present embodiment.

FIG. 8 is a diagram showing a reflection region of the adjustment mirror in the present embodiment.

FIG. 9 is a diagram showing non-deviation peak information in the present embodiment.

FIG. 10 is a diagram showing information detected in an optical axis deviation detection mode in the present embodiment.

FIG. 11 is a diagram showing an example of a correspondence table in the present embodiment.

FIG. 12 is a diagram showing outer shape information in the present embodiment.

FIG. 13 is a diagram showing a functional configuration example of the optical axis deviation detecting device in the present embodiment.

FIG. 14 is a flowchart of the optical axis deviation detecting device in the present embodiment.

FIG. 15 is a flowchart of the optical axis deviation detecting device in the present embodiment.

FIG. 16 is a diagram showing a reflection region of an adjustment mirror in another embodiment.

FIG. 17 is a diagram showing a reflection region of an adjustment mirror in another embodiment.

FIG. 18 is a diagram showing a reflection region of the adjustment mirror in another embodiment.

FIG. 19 is a diagram showing a configuration example of the optical axis deviation detecting device in another embodiment.

FIG. 20 is a diagram showing a reflection region of an adjustment mirror in another embodiment.

### DESCRIPTION OF EMBODIMENTS

Embodiments of the present invention will be described in detail with reference to the drawings. Like or corresponding parts in the drawings are denoted by like reference signs and a description thereof is not always repeated.

### First Embodiment

### APPLICATION EXAMPLES

In self-driving of a movable body, remote sensing (remote measurement) technique for detecting the presence/absence of a target and the distance from the movable body to the target is employed in a target detection device 900. Target detection device 900 is typically a LIDAR (Light Detection and Ranging, Laser Imaging Detection and Ranging).

The resolutions in a scan range in the horizontal direction and a scan range in the vertical direction are defined by angles for each individual target detection device 900. Target detection device 900 can perform three-dimensional measurement in a wide range by detecting a target in a certain range. In target detection device 900, when an optical axis deviation of laser light occurs, an error in distance from the target to the movable body increases. It is therefore important to detect the occurring optical axis deviation. The optical axis deviation detecting device in the present embodiment detects the occurring optical axis deviation.

In the present embodiment, examples of “movable body” include vehicles (automobiles), motorcycles, trains, and flying objects (for example, drones). The movable body switches between a normal driving mode and a driving assistance mode, based on the operation by the user (for example, driver, operator, etc.). The normal driving mode is a mode in which the vehicle is driven by driving operation by the driver of the movable body. The driving assistance mode is a mode in which an assistance device mounted on the movable body drives the movable body. The driving assistance mode includes a first driving assistance mode in which driving operation by the user is not accepted and a second driving assistance mode in which driving operation by the user is accepted. The first driving assistance mode is a mode in which driving operation by the user is not accepted. The first driving assistance mode is therefore a mode in which the movable body moves by self-driving of the movable body without the user's driving operation. The second driving assistance mode is a mode in which driving operation by the user is accepted. The second driving assistance mode is therefore a mode in which the movable body moves based on self-driving of the movable body and driving operation by the user. For example, during the second driving assistance mode, the movable body stops when the user steps on the brake during moving by self-driving of the movable body.

In the present embodiment, a description is given assuming that the movable body is a vehicle. The optical axis deviation detecting device is mounted on target detection device 900. Target detection device 900 is mounted on a movable body. Target detection device 900 detects information about a target present outside the movable body. The target includes other vehicles, humans, signs, and other obstacles. The target information about a target includes, for example, at least one of information indicating the presence/absence of a target and information indicating the distance from the movable body to the target. The process of detecting target information is referred to as “target detection process”. Target detection device 900 performs the target detection process, based on laser light from a laser output unit. Laser light may be pulsed light or may be continuous light. A reference axis (reference direction) of the optical axis of laser light from the laser output unit is predetermined.

Based on the premise that the optical axis of laser light is the reference axis, target detection device 900 performs the target detection process. However, the optical axis of laser light may deviate from the reference axis, for example, due to external force applied to the vehicle equipped with target detection device 900. Such a deviation is hereinafter referred to as “optical axis deviation”. If the movable body executes driving in the driving assistance mode with an optical axis deviation as it is, the presence/absence of a target and the distance from the movable body to the target may fail to be detected.

The optical axis deviation detecting device in the present embodiment then detects an optical axis deviation. In the present embodiment, the control may be directed to an optical axis deviation detection mode, in addition to the normal driving mode and the driving assistance mode. In the optical axis deviation detection mode, the optical axis deviation detecting device can detect an optical axis deviation. As a modification, the control may be directed to the optical axis deviation detection mode, concurrently with at least one of the normal driving mode and the driving assistance mode.

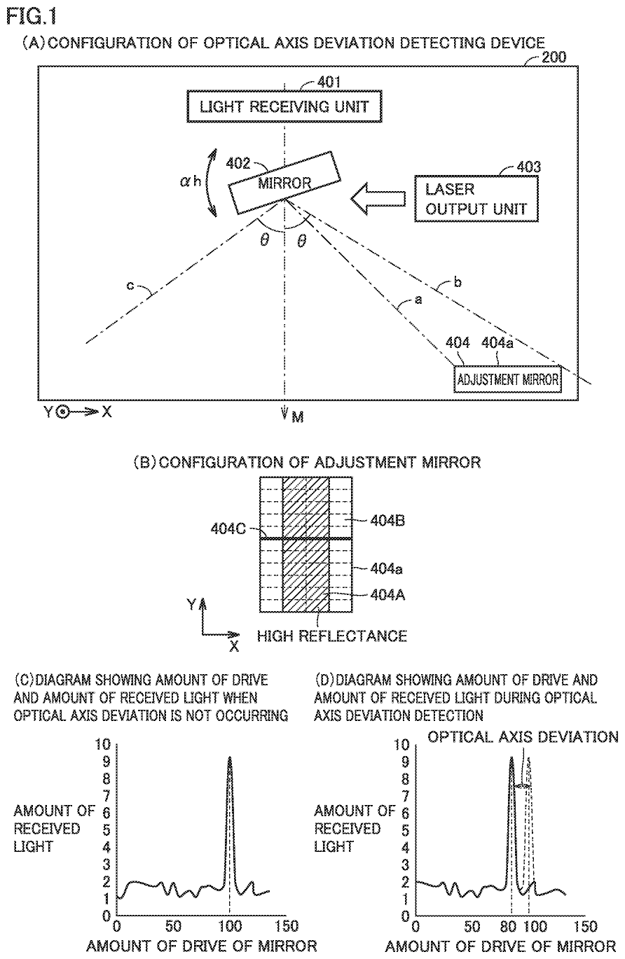

FIG. 1 is a diagram for explaining an example of a scene to which the optical axis deviation detecting device in the present embodiment is applied. First referring to FIG. 1, an example of a scene to which the optical axis deviation detecting device in the present embodiment is applied will be described.

In the present embodiment, a method of detecting an optical axis deviation includes a first method and a second method. FIG. 1 is a diagram for explaining the first method. As shown in FIG. 1(A), optical axis deviation detecting device 200 in the present embodiment includes a light receiving unit 401, a laser output unit 403, a mirror 402, and an adjustment mirror 404.

In the driving assistance mode, target detection device 900 performs the target detection process, using light receiving unit 401, laser output unit 403, and mirror 402. Typically, target detection device 900 outputs laser light from laser output unit 403 to mirror 402. Mirror 402 is a reflective member that reflects the output laser light. Mirror 402 may be formed of any other material that reflects laser light. For mirror 402, a reference direction M serving as a reference is set in an output direction of reflected light at mirror 402. Mirror 402 can be driven along a horizontal direction αh with reference direction M as a reference. The amount of drive of mirror 402 is expressed, assuming that the amount of drive in the vertical direction and the horizontal direction of mirror 402 is “0” when the output direction of reflected light at mirror 402 is reference direction M.

Although not shown in the drawing, mirror 402 can be driven also in the vertical direction. That is, mirror 402 performs driving to change the output direction of output light (laser output unit 403).

It is noted that the vertical direction is the height direction of the movable body. The horizontal direction is a direction orthogonal to the vertical direction, for example, a moving direction of the movable body. In FIG. 1, the horizontal direction is the X-axis direction, and the vertical direction is the Y-axis direction. Light receiving unit 401 is illustrated in a small size in the example in FIG. 1(A) but actually configured to receive all reflected light from a target.

Target detection device 900 can output laser light in various directions by driving mirror 402. When a target is present outside the vehicle, laser light is reflected by the target and input as reflected light to light receiving unit 401. Target detection device 900 performs the target detection process, based on the light input to light receiving unit 401. Typically, target detection device 900 performs the target detection process, based on “the amount of received light by light receiving unit 401 (the quantity of reflected light from a target)”, “the time taken from when laser output unit 403 outputs laser light to when light receiving unit 401 receives light”, and “the amount of drive of mirror 402 (the output direction of reflected light from mirror 402)”, and the like.

Referring now to FIG. 1(A), the process in optical axis deviation detecting device 200 will be described. When controlled in the optical axis deviation detection mode, optical axis deviation detecting device 200 performs the process of detecting an optical axis deviation.

First of all, optical axis deviation detecting device 200 outputs laser light from laser output unit 403 to mirror 402. Mirror 402 can be driven over a predetermined angle in the horizontal direction α.

In adjustment mirror 404, a main surface on the mirror 402 side of the main surfaces of adjustment mirror 404 includes a reflection region 404a. Optical axis deviation detecting device 200 drives mirror 402 such that reflected light from mirror 402 uniformly impinges on the X-axis direction of reflection region 404a of adjustment mirror 404. In the example in FIG. 1, when mirror 402 is driven until the output direction of reflected light from mirror 402 comes from direction a to direction b, reflected light from mirror 402 uniformly impinges on the X-axis direction of reflection region 404a. In the present embodiment, optical axis deviation detecting device 200 drives mirror 402 such that reflected light from mirror 402 uniformly impinges on line 404C shown in FIG. 1(B).

Reflected light reflected by reflection region 404a (reflected light from mirror 402) is received by light receiving unit 401. Although light receiving unit 401 is illustrated in a small size in the example in FIG. 1(A), light receiving unit 401 is actually configured to receive all reflected light from the adjustment mirror.

FIG. 1(B) is a diagram for explaining reflection region 404a of adjustment mirror 404. As shown in FIG. 1(B), reflection region 404a includes a high reflection region 404A (first region) and a low reflection region 404B (second region). The reflectance of light of low reflection region 404B (second region) is lower than that of high reflection region 404A (first region). In the example in FIG. 1(B), high reflection region 404A is hatched, and low reflection region 404B is not hatched.

When reflected light from mirror 402 is reflected by reflection region 404a, light receiving unit 401 receives the reflected light. The amount of received light by light receiving unit 401 for the reflected light reflected by high reflection region 404A is higher than the amount of received light by light receiving unit 401 for the reflected light reflected by low reflection region 404B. The amount of received light by light receiving unit 401 for the reflected light reflected by high reflection region 404A may reach a “peak”. On the other hand, the amount of received light by light receiving unit 401 for the reflected light reflected by low reflection region 404B is low. The amount of received light by light receiving unit 401 for the reflected light reflected by low reflection region 404B may reach an “inverse peak”.

FIG. 1(C) is a diagram showing the relation between the amount of drive of mirror 402 and the amount of received light by light receiving unit 401 in a case where an optical axis deviation is not occurring. The horizontal axis shows the amount of drive of mirror 402, and the vertical axis shows the amount of received light by light receiving unit 401. In the example in FIG. 1(C), in a case where an optical axis deviation is not occurring, the amount of received light reaches a peak when the amount of drive of mirror 402 is “100”. Optical axis deviation detecting device 200 stores beforehand the amount of drive of mirror 402 (100 in the example in FIG. 1(C)) at which the amount of received light reaches a peak. In other words, optical axis deviation detecting device 200 stores the output direction in which the amount of received light by light receiving unit 401 reaches a peak based on reflection by high reflection region 404A (first region) in a case where an optical axis deviation of mirror 402 is not occurring. This output direction is a direction in which reflected light is output from mirror 402 at the amount of drive “100”. This output direction is information stored beforehand, for example, at the time of manufacture of optical axis deviation detecting device 200 (target detection device 900). The stored output direction may be referred to as “information on output direction” or may be simply referred to as “output direction”. The information on output direction is typically information indicating the angle formed between reference direction M and the optical axis of reflected light from mirror 402.

FIG. 1(D) is a diagram showing the relation between the amount of drive of mirror 402 and the amount of received light by light receiving unit 401 during the optical axis deviation detection mode. In the optical axis deviation detection mode, the relation is as shown in FIG. 1(D) when mirror 402 is driven such that reflected light from mirror 402 uniformly impinges on line 404C of reflection region 404a of adjustment mirror 404. Optical axis deviation detecting device 200 acquires the amount of drive when the amount of received light by light receiving unit 401 reaches a peak. In the example in FIG. 1(D), the amount of drive of mirror 402 at which the amount of received light reaches a peak is “80”. In other words, during the optical axis deviation detection mode, optical axis deviation detecting device 200 acquires the output direction when the amount of received light by light receiving unit 401 reaches a peak. This output direction is a direction in which reflected light is output from mirror 402 at the amount of drive “80”. The acquired output direction may be referred to as “information on output direction” or may be simply referred to as “output direction”.

Optical axis deviation detecting device 200 can detect an optical axis deviation of reflected light from mirror 402, based on the amount of drive (information on output direction) at which the amount of received light by light receiving unit 401 that is stored beforehand and the amount of drive (information on output direction) at which the amount of received light by light receiving unit 401 reaches a peak that is acquired during the optical axis deviation detection mode.

In the example in FIG. 1(C), the amount of drive of mirror 402 that is stored beforehand (the amount of drive in a case where an optical axis deviation is not occurring) is “100”, and in the example in FIG. 1(D), the amount of drive of mirror 402 that is acquired during the optical axis deviation detection mode is “80”. Optical axis deviation detecting device 200 detects an optical axis deviation corresponding to the amount of drive “20” by calculating the difference between “100” and “80”.

In the example in FIG. 1, the optical axis deviation includes at least one of a deviation of mirror 402 from the reference position and a deviation of the optical axis of laser output unit 403.

In this way, according to the first method, optical axis deviation detecting device 200 detects an optical axis deviation, based on the amount of drive (output direction) at which the amount of received light by light receiving unit 401 reaches a peak.

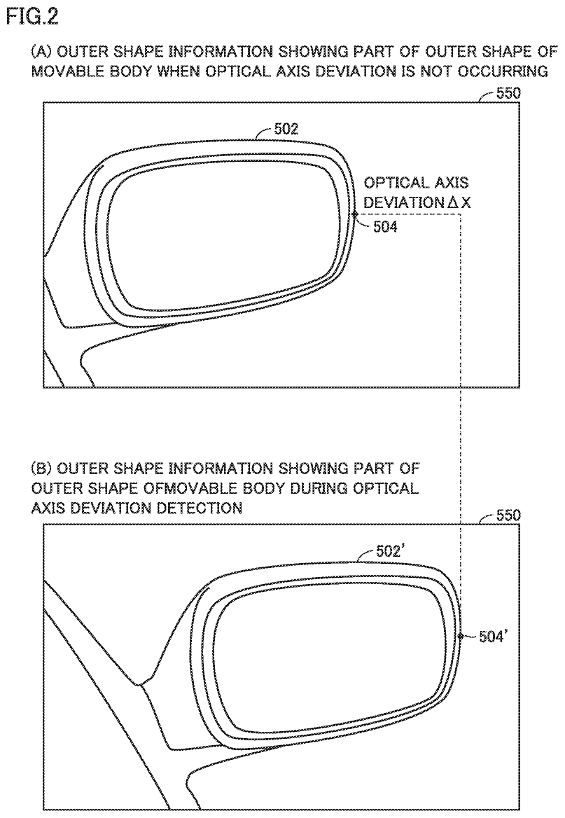

FIG. 2 is a diagram for explaining the second method. The second method is a method of detecting an optical axis deviation, using light receiving unit 401, laser output unit 403, and mirror 402 in FIG. 1(A), but not using adjustment mirror 404.

In the second method, optical axis deviation detecting device 200 allows driving of mirror 402 within a predetermined drive range in a case where an optical axis deviation is not occurring, and light receiving unit 401 receives reflected light from a target outside optical axis deviation detecting device 200. Here, the target includes a part of the movable body. The predetermined drive range includes a drive range in the horizontal direction and a drive range in the vertical direction. The range in the horizontal direction is a drive range in which the output direction of reflected light from mirror 402 comes from direction b to direction c. In the example in FIG. 1(A), the angle between direction b and reference direction M and the angle between direction c and reference direction M are identical (both are angle θ). The drive direction in the vertical direction is not illustrated in FIG. 1.

Optical axis deviation detecting device 200 generates outer shape information, based on “the amount of received light by light receiving unit 401 (the quantity of reflected light from a target)”, “the time from when laser output unit 403 outputs laser light to when light receiving unit 401 receives light”, and “the amount of drive of mirror 402 (the output direction of reflected light from mirror 402)”, and the like, and stores this outer shape information into a predetermine storage area. The outer shape information is information indicating a part of the outer shape of the movable body.

In this way, optical axis deviation detecting device 200 generates outer shape information beforehand by a predetermined method (for example, a generation program) by allowing driving of mirror 402 in a predetermined drive range in a case where an optical axis deviation is not occurring. Optical axis deviation detecting device 200 stores the outer shape information in a case where an optical axis deviation is not occurring into a predetermined storage area.

This outer shape information is information generated and stored beforehand, for example, at the time of manufacture of optical axis deviation detecting device 200 (target detection device 900).

FIG. 2(A) shows the outer shape information in a case where an optical axis deviation is not occurring (the outer shape information stored beforehand). An overall image 550 is information generated by optical axis deviation detecting device 200 allowing driving of mirror 402 in a predetermined drive range. In the example in FIG. 2(A), a right-side mirror 502 is shown as outer shape information, slightly to the left side in overall image 550. Although not shown in FIG. 2, information such as another target is generated in a region other than the outer shape information of right-side mirror 502 in overall image 550.

During the optical axis deviation detection mode, optical axis deviation detecting device 200 generates and acquires outer shape information by allowing driving of mirror 402 in a predetermined drive range. Here, the drive range of mirror 402 is the same as the drive range for generating outer shape information to be stored beforehand (see FIG. 2(A)). The method for generating outer shape information (for example, a generation program) is the same as the method for generating outer shape information to be stored beforehand (see FIG. 2(A)).

FIG. 2(B) shows outer shape information generated by optical axis deviation detecting device 200 during the optical axis deviation detection mode. In the example in FIG. 2(B), a right-side mirror 502′ is shown as outer shape information, at the midsection in overall image 550.

Here, optical axis deviation detecting device 200 detects an optical axis deviation, based on the outer shape information stored beforehand in a storage area (FIG. 2(A)) and the acquired outer shape information (FIG. 2(B)). In the example in FIG. 2, for example, attention is paid to a point 504 in the outer shape information and a point 504′ in the outer shape information. Then, point 504′ deviates from point 504 in the horizontal direction by Δx. Optical axis deviation detecting device 200 detects this Δx as an optical axis deviation in the horizontal direction. For easy understanding of FIG. 2, the ratio of the area of right-side mirror 502 in overall image 550 is increased, but in actuality, this ratio may be reduced.

In this way, according to the second method, optical axis deviation detecting device 200 detects an optical axis deviation, based on the outer shape information indicating a part of the movable body.

In the first method, optical axis deviation detecting device 200 detects an optical axis deviation, using adjustment mirror 404 included in optical axis deviation detecting device 200. In the second method, optical axis deviation detecting device 200 detects an optical axis deviation, using a part of the outer shape of the movable body equipped with optical axis deviation detecting device 200. Optical axis deviation detecting device 200 therefore can detect an optical axis deviation even without the target board located outside optical axis deviation detecting device 200 (see PTL 1).

In the following embodiment, optical axis deviation detecting device 200 performs detection of an optical axis deviation by the first method and detection of an optical axis deviation by the second method. As a modification, optical axis deviation detecting device 200 may perform any one method of the detection of an optical axis deviation by the first method and the detection of an optical axis deviation by the second method.

### OVERALL CONFIGURATION OF MOVABLE BODY AND THE LIKE

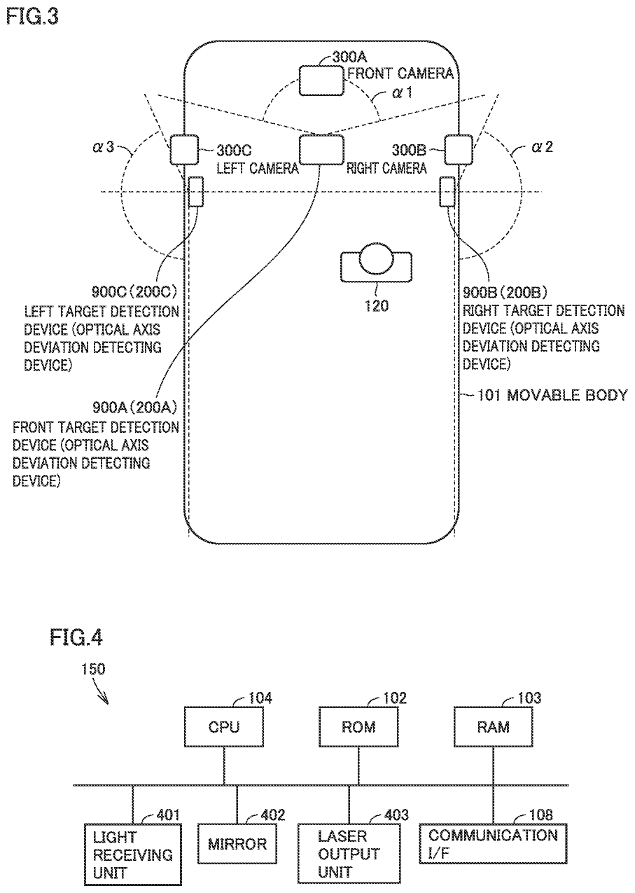

FIG. 3 is a diagram showing a movable body 101 in the present embodiment. In the example in FIG. 3, target detection modules are mountable on the front side, the right side, and the left side of movable body 101. The target detection module on the front side of movable body 101 includes a front camera 300A and a front target detection device 900A. The target detection module on the front side of movable body 101 includes a front camera 300A and a front target detection device 900A. The target detection module on the right side of movable body 101 includes a right camera 300B and a right target detection device 900B. The target detection module on the left side of movable body 101 includes a left camera 300C and a left target detection device 900C.

Front camera 300A captures an image in front of movable body 101. Right camera 300B captures an image to the right of movable body 101. Left camera 300C captures an image to the left of movable body 101.

Front target detection device 900A detects target information in front of movable body 101. Right target detection device 900B detects target information to the right of movable body 101. Left target detection device 900C detects target information to the left of movable body 101.

Front target detection device 900A, right target detection device 900B, and left target detection device 900C each include optical axis deviation detecting device 200.

Hereinafter, front cameras 300A, 300B, and 300C are collectively referred to as “camera 300”. Hereinafter, front target detection device 900A, right target detection device 900B, and left target detection device 900C are collectively referred to as “target detection device 900”.

During the driving assistance mode, movable body 101 executes self-driving, based on image information captured by camera 300, target information detected by target detection device 900, and the like. In FIG. 3, a driver 120 in movable body 101 is shown.

Angle α1 in FIG. 3 indicates the range of the output direction of reflected light from mirror 402 of optical axis deviation detecting device 200 in front target detection device 900A. Angle α2 in FIG. 3 indicates the range of the output direction of reflected light from mirror 402 of optical axis deviation detecting device 200 in right target detection device 900B. Angle α3 in FIG. 3 indicates the range of the output direction of reflected light from mirror 402 of optical axis deviation detecting device 200 in left target detection device 900C.

Front target detection device 900A, right target detection device 900B, and left target detection device 900C are each installed such that a part of the outer shape of movable body 101 is included in the range of the output direction of reflected light from mirror 402 of optical axis deviation detecting device 200. For example, as shown in FIG. 2, right target detection device 900B is installed such that right-side mirror 502 of movable body 101 is included in range of the output direction of reflected light from mirror 402.

### HARDWARE CONFIGURATION EXAMPLE OF OPTICAL AXIS DEVIATION DETECTING DEVICE

FIG. 4 is a diagram showing a hardware configuration example of optical axis deviation detecting device 200. Optical axis deviation detecting device 200 includes a CPU 104 (Central Processing Unit) executing a program, a ROM 102 (Read Only Memory) storing data in a nonvolatile manner, a RAM 103 (Random Access Memory) storing data in a volatile manner, and a communication IF (Interface) 108 capable of communicating with an external device.

Optical axis deviation detecting device 200 further includes light receiving unit 401, mirror 402, and laser output unit 403. These pieces of hardware are connected to each other through a data bus.

### CONCEPTUAL DIAGRAM OF MOVABLE BODY, TARGET DETECTION DEVICE 900, AND OPTICAL AXIS DEVIATION DETECTING DEVICE

FIG. 5 is a conceptual diagram of movable body 101, target detection device 900, and optical axis deviation detecting device 200. Movable body 101 is equipped with target detection device 900. Target detection device 900 includes optical axis deviation detecting device 200. Target detection device 900 also includes a target detector 902.

Target detector 902 receives light output from laser output unit 403 and reflected by a target and detects target information based on the amount of received light.

### CONFIGURATION EXAMPLE OF OPTICAL AXIS DEVIATION DETECTING DEVICE

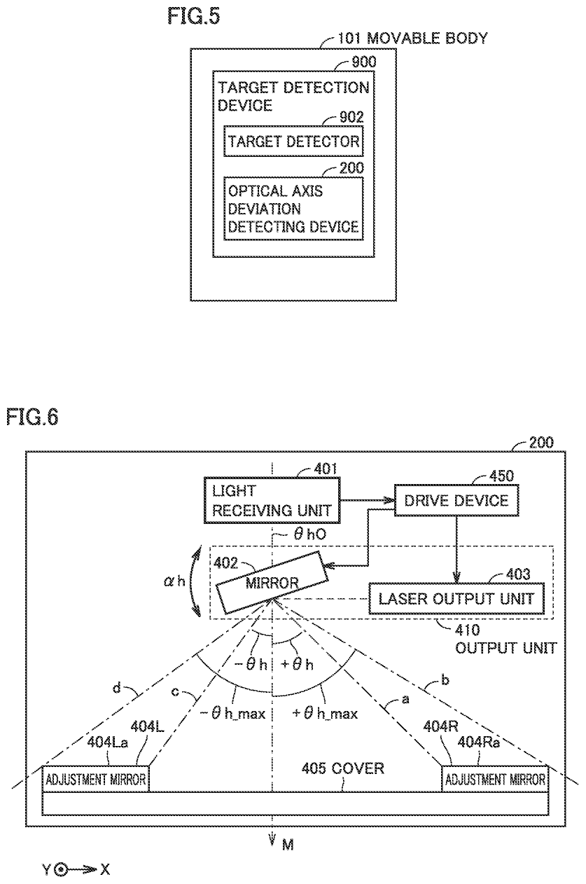

FIG. 6 is a diagram showing optical axis deviation detecting device 200 in the present embodiment. FIG. 6 shows the detail of FIG. 1.

Optical axis deviation detecting device 200 includes light receiving unit 401, an output unit 410, a drive device 450, a left-side adjustment mirror 404L, a right-side adjustment mirror 404R, and a cover 405. Output unit 410 includes mirror 402 and laser output unit 403. Laser output unit 403 outputs laser light to mirror 402 under the control of drive device 450. Mirror 402 can be driven in a predetermined drive range under the control of drive device 450. That is, laser output unit 403 performs driving to change the output direction of output light (reflected light by mirror 402) under the control of drive device 450. Left-side adjustment mirror 404L and right-side adjustment mirror 404R may be collectively referred to as adjustment mirror 404.

Light receiving unit 401, mirror 402, and laser output unit 403 are as described above with reference to FIG. 1. Drive device 450 performs driving of mirror 402 and driving of laser output unit 403. Drive device 450 is configured with, for example, CPU 104, ROM 102, and RAM 103.

Adjustment mirror 404L and adjustment mirror 404R are installed at cover 405. Cover 405 is a material that allows reflected light from mirror 402 to pass through. A main surface on the mirror 402 side of the main surfaces of adjustment mirror 404 includes reflection region 404a. For example, left-side adjustment mirror 404L includes a reflection region 404La. Right-side adjustment mirror 404R includes a reflection region 404Ra.

Mirror 402 can be driven in the horizontal direction αh as a second direction and in the vertical direction αv (not shown) as a first direction, under the control of drive device 450.

During the optical axis deviation detection mode, mirror 402 performs driving to change the output direction (reflection direction) of reflected light from mirror 402 within a range including a first drive range and a second drive range different from the first drive range, under the control of drive device 450.

In the present embodiment, the first drive range is a range from “the direction in which the angle between the output direction (reflection direction) of reflected light from mirror 402 and reference direction M is −θh” to “the direction in which the angle between the output direction (reflection direction) of reflected light from mirror 402 and reference direction M is +θh”.

The second drive range includes a range from “the direction in which the angle between the output direction (reflection direction) of reflected light from mirror 402 and reference direction M is −θh_max” to “the direction in which the angle between the output direction (reflection direction) of reflected light from mirror 402 and reference direction M is −θh” and a range from “the direction in which the angle between the output direction (reflection direction) of reflected light from mirror 402 and reference direction M is +θh_max” to “the direction in which the angle between the output direction (reflection direction) of reflected light from mirror 402 and reference direction M is +θh”.

Here, +θh_max>+θh, and |−θh_max|>|−θh|. |X| represents the absolute value of a numerical value X.

In the example in FIG. 6, the first drive range is a range in which the output direction of reflected light from mirror 402 falls between direction a and direction c. The second drive range is a range in which the output direction of reflected light from mirror 402 falls between direction a and direction b and a range in which the output direction of reflected light from mirror 402 falls between direction c and direction d.

That is, during the optical axis deviation detection mode, mirror 402 is driven in the horizontal direction αh, under the control of drive device 450, in a range from “the direction in which the angle between the output direction (reflection direction) of reflected light from mirror 402 and reference direction M is −θh_max” to “the direction in which the angle between the output direction (reflection direction) of reflected light from mirror 402 and reference direction M is +θh_max”. In other words, mirror 402 is driven in the horizontal direction αh in a range in which the output direction (reflection direction) of reflected light from mirror 402 falls between direction d and direction b. Hereinafter, the drive range of mirror 402 during the optical axis deviation detection mode may be referred to as “first drive range+second drive range”.

On the other hand, during the driving assistance mode (during driving assistance of movable body 101), mirror 402 is driven in the first drive range under the control of drive device 450. In other words, mirror 402 is driven in a range in which the output direction (reflection direction) of reflected light from mirror 402 falls between direction a and direction c. Therefore, the drive range of mirror 402 is wider during the optical axis deviation detection mode than during the driving assistance mode.

In the example in FIG. 6, adjustment mirror 404 is arranged at a position where reflected light from mirror 402 is reflected by adjustment mirror 404 when mirror 402 is driven in the second drive range. During the driving assistance mode (during driving assistance of movable body 101), mirror 402 is driven in the first drive range under the control of drive device 450. Therefore, in target detection during the driving assistance mode, reflected light from mirror 402 does not impinge on adjustment mirror 404. It is therefore possible to prevent target detection during the driving assistance mode from being interrupted by adjustment mirror 404.

In the example in FIG. 6, adjustment mirrors 404L are provided at both ends of the drive range in the second direction (horizontal direction αh) of mirror 402. In the example in FIG. 6, left-side adjustment mirror 404L and right-side adjustment mirror 404R are provided at both ends of the drive range in the second direction (horizontal direction αh) of mirror 402. In the example in FIG. 6, right-side adjustment mirror 404R is provided at one end in the +direction from reference direction M in the horizontal direction αh. On the other hand, left-side adjustment mirror 404L is provided at one end in the −direction from reference direction M in the horizontal direction αh.

Hereinafter, the driving from when the output direction of light from mirror 402 is reference direction M to when it is direction b is referred to as “driving in the +direction”, and the driving from when the output direction of light from mirror 402 is reference direction M to when it is direction d is referred to as “driving in the −direction”. The amount of drive in the driving in the +direction is represented by a “+numerical value”, and the amount of drive in the driving in the −direction is represented by a “−numerical value”.

Under the control of drive device 450, mirror 402 is driven in the vertical direction αv in a range from “the direction in which the angle between the output direction (reflection direction) of reflected light from mirror 402 and reference direction M is +30 degrees” to “the direction in which the angle between the output direction (reflection direction) of reflected light from mirror 402 and reference direction M is −30 degrees”, either during the driving assistance mode or during the optical axis deviation detection mode.

### CONFIGURATION OF ADJUSTMENT MIRROR

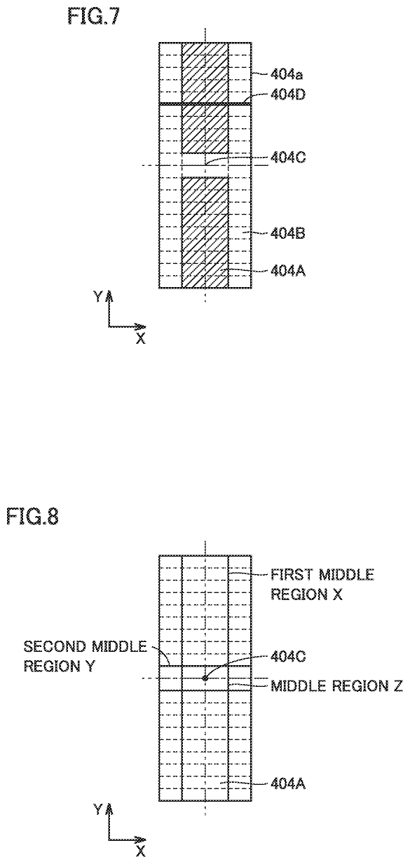

FIG. 7 and FIG. 8 are diagrams showing an example of reflection region 404a (in the example in FIG. 6, reflection region 404Ra and reflection region 404La) of the adjustment mirror. FIG. 7 and FIG. 8 both show reflection region 404a, in which FIG. 7 shows high reflection region 404A, low reflection region 404B, and the like, and FIG. 8 shows a middle region Z and the like. In the example in FIG. 7, reflection region 404a includes high reflection region 404A (first region) and low reflection region 404B (second region). In the example in FIG. 7, 80 cells are illustrated by broken lines and solid lines.

As shown in FIG. 8, a region of four cells including point 404C is referred to as “middle region Z”. In reflection region 404a, a region of a midsection along the first direction (vertical direction) is referred to as “first middle region X”. In reflection region 404a, a region of a midsection along the second direction (horizontal direction) is referred to as “second middle region Y”. The region where first middle region X and second middle region Y overlap is “middle region Z”.

High reflection region 404A (first region) is first middle region X of the midsection along the first direction (vertical direction), excluding second middle region Y of the midsection along the second direction. That is, high reflection region 404A is a hatched region in FIG. 7.

Low reflection region 404B (second region) includes second middle region Y and a region excluding first middle region X. That is, low reflection region 404B is a region not hatched in FIG. 7. As shown in FIG. 7, adjustment mirror 404 is configured such that the length in the vertical direction is longer than the length in the horizontal direction.

### NON-DEVIATION PEAK INFORMATION

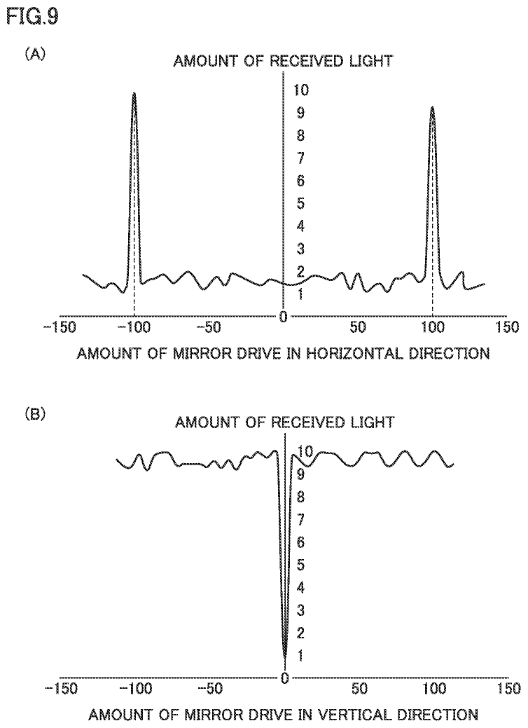

Non-deviation peak information will now be described. The non-deviation peak information is information used in the first method. FIG. 9 is a diagram for explaining the non-deviation peak information. The non-deviation peak information shown in FIG. 9 is a diagram showing the detail of FIG. 1(C). The non-deviation peak information is information indicating the amount of drive of mirror 402 at the time of a peak of the amount of received light and the amount of mirror 402 at the time of an inverse peak of the amount of received light in a case where an optical axis deviation is not occurring.

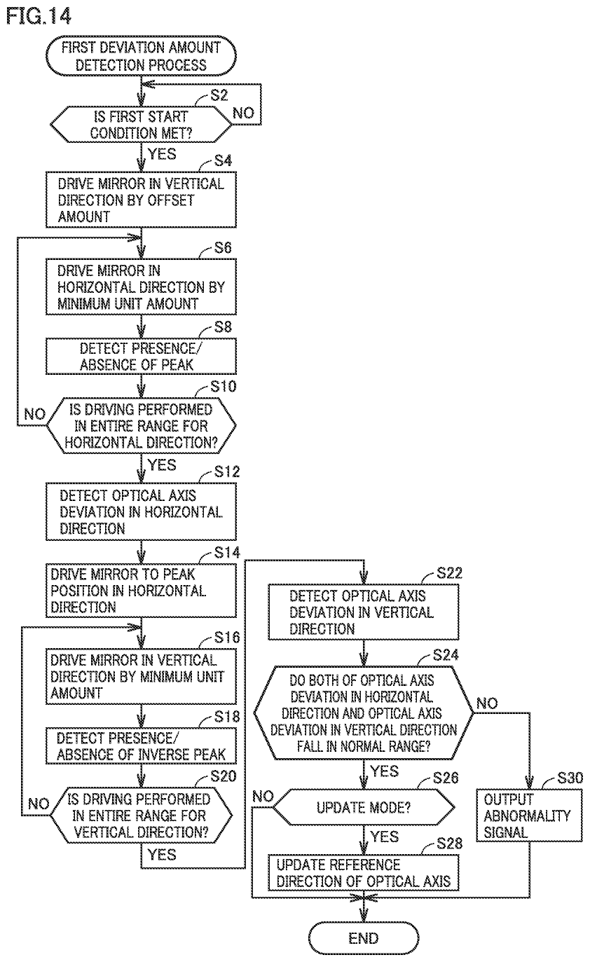

FIG. 9(A) shows a peak in the horizontal direction. In the example in FIG. 9(A), in the horizontal direction, the amount of received light reaches a peak when the amount of drive in the horizontal direction of mirror 402 is “+100” and when the amount of drive in the horizontal direction of mirror 402 is “−100”. In the example in FIG. 9(A), the peak is reached when mirror 402 is driven in the horizontal direction after mirror 402 is driven in the vertical direction such that the reflected light from mirror 402 impinges, for example, on high reflection region 404A. The amount by which mirror 402 is driven in the vertical direction such that the reflected light impinges on high reflection region 404A corresponds to “offset amount” described in step S4 in FIG. 14.

In the example in FIG. 9(A), in a case where mirror 402 is driven in the horizontal direction, the amount of received light by light receiving unit 401 is low when the reflected light from mirror 402 impinges on cover 405 and the reflected light from mirror 402 impinges on low reflection region 404B. On the other hand, when the reflected light from mirror 402 impinges on high reflection region 404A, the amount of received light by light receiving unit 401 is high (the amount of received light reaches a peak).

FIG. 9(B) shows an inverse peak in the vertical direction. In the example in FIG. 9(B), when the amount of drive in the vertical direction of mirror 402 is “0”, the amount of received light reaches an inverse peak. In the example in FIG. 9(B), the peak is reached when mirror 402 is driven in the vertical direction after mirror 402 is driven by the amount of drive that achieves a peak in the horizontal direction (that is, +100 or −100 in the horizontal direction). In other words, in the example in FIG. 9(B), the peak is reached, for example, when mirror 402 is driven in the vertical direction after mirror 402 is driven such that the reflected light from mirror 402 impinges on middle region Z (see FIG. 8). In the example in FIG. 9(B), in a case where mirror 402 is driven in the vertical direction, the amount of received light by light receiving unit 401 is high when the reflected light from mirror 402 impinges on high reflection region 404A. On the other hand, when the reflected light from mirror 402 impinges on low reflection region 404B, the amount of received light by light receiving unit 401 is low (the amount of received light reaches an inverse peak).

The non-deviation peak information shown in FIG. 9(A) and FIG. 9(B) is information generated, for example, at the time of manufacture of optical axis deviation detecting device 200 (target detection device 900) and stored beforehand.

### AMOUNT OF RECEIVED LIGHT DURING OPTICAL AXIS DEVIATION DETECTION MODE

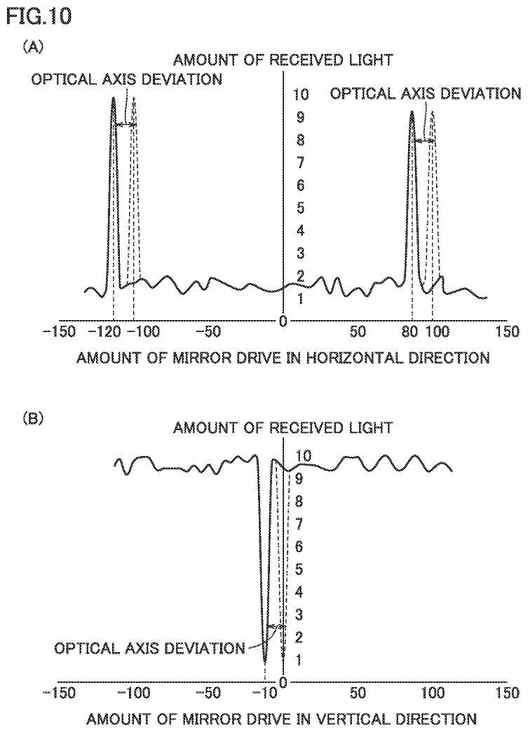

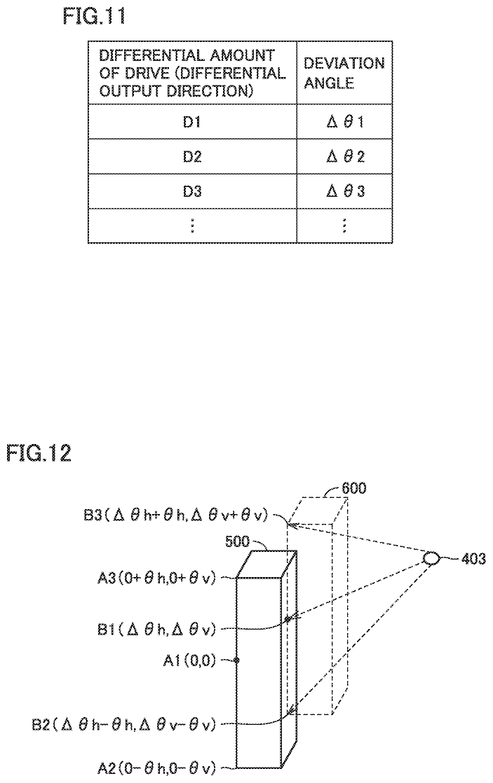

The amount of received light during the optical axis deviation detection mode will now be described. FIG. 10 is a diagram for explaining the amount of received light during the optical axis deviation detection mode. During the optical axis deviation detection mode, drive device 450 drives output unit 410 to acquire a peak and an inverse peak of the amount of received light. Here, the drive range of mirror 402 for acquiring a peak and an inverse peak of the amount of received light in the optical axis deviation detection mode is the same as the drive range for generating the non-deviation peak information. The method (for example, an acquisition program) for acquiring a peak and an inverse peak of the amount of received light in the optical axis deviation detection mode is the same as the method for generating the non-deviation peak information. Both the drive range and the method (for example, an acquisition program) being the same in this way is referred to as “the same manner”.

During the optical axis deviation detection mode, as described in the generation of non-deviation peak information, optical axis deviation detecting device 200 drives mirror 402 in the vertical direction by a predetermined offset amount such that the reflected light from mirror 402 impinges on high reflection region 404A. Subsequently, optical axis deviation detecting device 200 drives mirror 402 in the horizontal direction to detect an optical axis deviation in the horizontal direction. This predetermined offset amount will be described in step S4 in FIG. 14.

Supposing that an optical axis deviation is not occurring during the optical axis deviation detection mode, “the peak and the inverse peak of the amount of received light acquired by optical axis deviation detecting device 200 during the optical axis deviation detection mode” respectively agree with “the peak and the inverse peak of the amount of received light in non-deviation peak information”.

However, in a case where an optical axis deviation is occurring, one of the following events occurs: an event in which the peak of the amount of received light acquired by optical axis deviation detecting device 200 during the optical axis deviation detection mode does not agree with the peak of the amount of received light in non-deviation peak information; and an event in which the inverse peak of the amount of received light acquired by optical axis deviation detecting device 200 does not agree with the inverse peak of the amount of received light in non-deviation peak information.

Optical axis deviation detecting device 200 in the present embodiment detects, as an optical axis deviation in the horizontal direction, the difference between the peak of the amount of received light acquired by optical axis deviation detecting device 200 during the optical axis deviation detection mode and the peak of the amount of received light in non-deviation peak information. Optical axis deviation detecting device 200 in the present embodiment detects, as an optical axis deviation in the vertical direction, the difference between the inverse peak of the amount of received light acquired by optical axis deviation detecting device 200 during the optical axis deviation detection mode and the inverse peak of the amount of received light in non-deviation peak information.

In the example in FIG. 10(A), in the horizontal direction, the amount of received light reaches a peak when the amount of drive in the horizontal direction of mirror 402 is “+80” and when the amount of drive in the horizontal direction of mirror 402 is “−120”. In the example in FIG. 10(B), when the amount of drive in the vertical direction of mirror 402 is “−10”, the amount of received light reaches an inverse peak.

Optical axis deviation detecting device 200 calculates “−20” as the differential amount of drive in the horizontal direction, based on non-deviation peak information. Optical axis deviation detecting device 200 calculates “−10” as the differential amount of drive in the vertical direction, based on non-deviation peak information. In this way, optical axis deviation detecting device 200 detects an optical axis deviation corresponding to the amount of drive 20 in the negative direction in the horizontal direction and an optical axis deviation corresponding to the amount of drive 10 in the negative direction in the vertical direction.

Optical axis deviation detecting device 200 calculates the angle Δθ of the deviating optical axis, based on the calculated differential amount of drive. For example, optical axis deviation detecting device 200 stores a correspondence table in a storage area, in which the differential amount of drive and the deviation angle Δθ are associated with each other. FIG. 11 is a diagram showing an example of the correspondence table. In the example in FIG. 11, the differential amount of drive D1 is associated with deviation angle Δθ1, the differential amount of drive D2 is associated with deviation angle Δθ2, and the differential amount of drive D3 is associated with deviation angle Δθ3. FIG. 7 shows vertical ellipses, and these vertical ellipses indicate that any other correspondences between the differential amount of drive and the deviation angle are omitted. Although not shown in FIG. 11, the correspondence table includes a correspondence table for the horizontal direction and a correspondence table for the vertical direction.

As a modification, optical axis deviation detecting device 200 may use a correspondence formula rather than the correspondence table in FIG. 11. This correspondence formula is a formula for calculating deviation angle Δθ with input of the differential amount of drive D. For this correspondence formula, the correspondence table includes a correspondence formula in the horizontal direction and a correspondence formula in the vertical direction.

As described in parentheses in FIG. 11, the differential amount of drive can be represented as differential output direction. As previously mentioned, the output direction is “the direction in which reflected light is output from mirror 402”.

### OUTER SHAPE INFORMATION

The outer shape information used in the second method will now be described. FIG. 12 is a diagram showing the outer shape information. In FIG. 12, non-deviation outer shape information 500 is indicated by a solid line, and outer shape information 600 is indicated by a broken line. Non-deviation outer shape information 500 and outer shape information 600 are information indicating a part of the outer shape of movable body 101. Non-deviation outer shape information 500 and outer shape information 600 may be collectively referred to as outer shape information. For example, as described with reference to FIG. 2, the outer shape information is right-side mirror 502 of movable body 101.

Both of non-deviation outer shape information 500 and outer shape information 600 illustrate a simplified form of the outer shape information (see FIG. 2(A)) in a case where an optical axis deviation is not occurring. Non-deviation outer shape information 500 is information generated by optical axis deviation detecting device 200 allowing driving of mirror 402 in a predetermined drive range in a case where an optical axis deviation is not occurring. The predetermined drive range may be, for example, the first drive range in the horizontal direction. When optical axis deviation detecting device 200 employs a configuration in which the predetermined drive range is the first drive range, target detection device 900 is attached to a position where non-deviation outer shape information is generated when mirror 402 is driven in the first drive range in a case where an optical axis deviation is not occurring (when non-deviation shape information is generated).

The predetermined drive range may be, for example, first drive range+second drive range in the horizontal direction. When optical axis deviation detecting device 200 employs a configuration in which the predetermined drive range is first drive range+second drive range, target detection device 900 is attached to a position where non-deviation outer shape information is generated when mirror 402 is driven in the second drive range in a case where an optical axis deviation is not occurring (when non-deviation shape information is generated).

The predetermined drive range is not limited to the first drive range and the second drive range and may be any other drive range. Non-deviation outer shape information 500 is information generated and stored beforehand, for example, at the time of manufacture of optical axis deviation detecting device 200 (target detection device 900).

Outer shape information 600 in FIG. 12 illustrates a simplified form of the outer shape information (see FIG. 2(B)) generated by optical axis deviation detecting device 200 during the optical axis deviation detection mode. Optical axis deviation detecting device 200 generates and acquires outer shape information 600 by allowing driving of mirror 402 in a predetermined drive range. Here, optical axis deviation detecting device 200 drives mirror 402 in the same manner as when non-deviation outer shape information is generated.

Optical axis deviation detecting device 200 detects an optical axis deviation, based on non-deviation outer shape information 500 and outer shape information 600. Typically, optical axis deviation detecting device 200 detects corresponding points from among pixels (points) that constitute non-deviation outer shape information 500 and pixels (point) that constitute outer shape information 600.

In the example in FIG. 12, optical axis deviation detecting device 200 recognizes that point A1, point A2, and point A3 of non-deviation outer shape information 500 correspond to point B1, point B2, and point B3 of outer shape information 600, respectively.

In the example in FIG. 12, point Al of non-deviation outer shape information 500 is used as a reference point, and three points: point A1, point A2, and point A3 are represented by the drive angles of mirror 402. In the example in FIG. 12, point A1 is represented by (0, 0), point A2 is represented by (0−θh, 0−θv), and point A3 is represented by (0+θh, 0+θv).

For outer shape information 600, point B1 is represented by (Δθh, Δθv), point B2 is represented by (Δθh−θh, Δθv−θv), and point B3 is represented by (Δθh+θh, Δθv+θv).

Optical axis deviation detecting device 200 compares the coordinates represented by the respective angles for point B1 to point B3 with points A1 to point A3, respectively. In the example in FIG. 12, between point A1 to point A3 and point B1 to point B3, an angle deviation of Δθh is occurring in the horizontal direction, and an angle deviation of Δθv is occurring in the vertical direction.

A method of detecting corresponding points between non-deviation outer shape information 500 and outer shape information 600 will now be described. Non-deviation outer shape information 500 and outer shape information 600 are each generated based on the amount of received light by light receiving unit 401. Non-deviation outer shape information 500 and outer shape information 600 are constituted with a plurality of pixels as minimum units, and each of the pixels has a feature amount. The feature amount is, for example, “the amount of received light by light receiving unit 401 (the quantity of reflected light from a target)”, “the time from when laser output unit 403 outputs laser light to when light receiving unit 401 receives light”, and “the amount of drive of mirror 402 (the output direction of reflected light from mirror 402)”. The feature amount may include color information. The feature amount may be another information.

Optical axis deviation detecting device 200 detects pixels (points) having the same feature amount as corresponding points between non-deviation outer shape information 500 and outer shape information 600. In the example in FIG. 12, the feature amounts of point A1 and point B1 are the same, and optical axis deviation detecting device 200 recognizes that point A1 and point B1 correspond to each other. The feature amounts of point A2 and point B2 are the same, and optical axis deviation detecting device 200 recognizes that point A2 and point B2 correspond to each other. The feature amounts of point A3 and point B3 are the same, and optical axis deviation detecting device 200 recognizes that point A3 and point B3 correspond to each other. In the example in FIG. 2, the feature amounts of point 504′ and point 504′ are the same, and optical axis deviation detecting device 200 recognizes that point 504′ and point 504′ correspond to each other.

The installation of target detection device 900 will now be described. Camera 300 that constitutes a target detection module with target detection device 900 captures an image of a part of the outer shape of movable body 101. A control device (not shown) performs image processing for information obtained by the image capturing. Based on the image processing, target detection device 900 sets “the amount of received light by light receiving unit 401 (the quantity of reflected light from a target)”, “the time from when laser output unit 403 outputs laser light to when light receiving unit 401 receives light”, and “the amount of drive of mirror 402 (the output direction of reflected light from mirror 402)” as setting information. Target detection device 900 is installed at a position where information on the outer shape captured by target detection device 900 is the same information as the setting information.

### FUNCTIONAL CONFIGURATION EXAMPLE OF OPTICAL AXIS DEVIATION DETECTING DEVICE

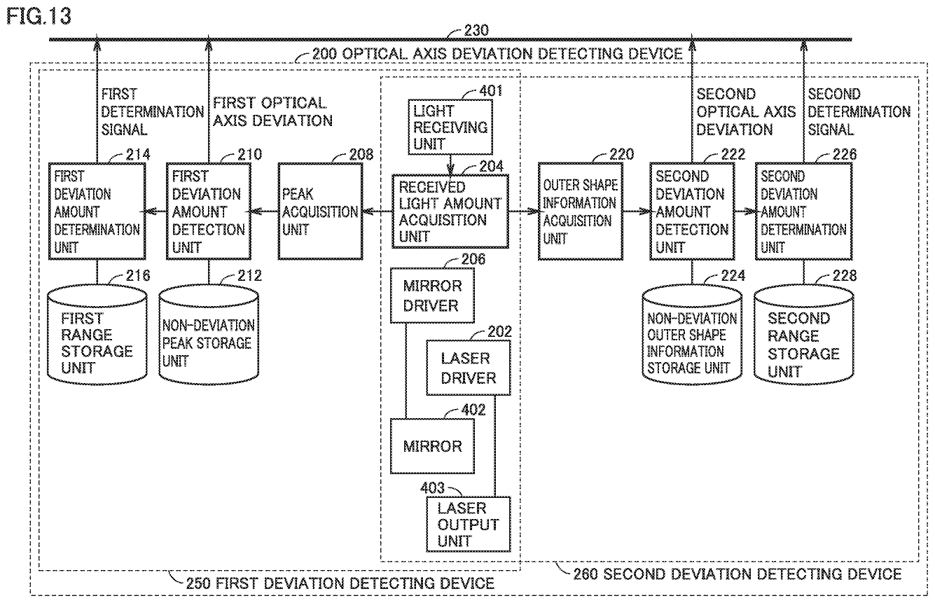

FIG. 13 is a diagram showing a functional configuration example of optical axis deviation detecting device 200. Optical axis deviation detecting device 200 includes a first deviation detecting device 250 and a second deviation detecting device 260.

First deviation detecting device 250 detects a first optical axis deviation. The first optical axis deviation is an optical axis deviation that can be detected using the first method described with reference to FIG. 1. As previously mentioned, the first method is a method of detecting an optical axis deviation using adjustment mirror 404 included in optical axis deviation detecting device 200.

Second deviation detecting device 260 detects a second optical axis deviation. The second optical axis deviation is an optical axis deviation that can be detected using the second method described with reference to FIG. 2. As previously mentioned, the second method is a method of detecting an optical axis deviation using a part of the outer shape of the movable body equipped with optical axis deviation detecting device 200.

First deviation detecting device 250 includes light receiving unit 401, a received light amount acquisition unit 204, a mirror driver 206, a laser driver 202, mirror 402, laser output unit 403, a peak acquisition unit 208, a first deviation amount detection unit 210, a first deviation amount determination unit 214, a non-deviation peak storage unit 212, and a first range storage unit 216.

Second deviation detecting device 260 includes light receiving unit 401, received light amount acquisition unit 204, mirror driver 206, laser driver 202, mirror 402, laser output unit 403, an outer shape information acquisition unit 220, a second deviation amount detection unit 222, a second deviation amount determination unit 226, a non-deviation outer shape information storage unit 224, and a second range storage unit 228.

Drive device 450 is configured with received light amount acquisition unit 204, mirror driver 206, laser driver 202, and the like.

First, first deviation detecting device 250 will be described. In the optical axis deviation detection mode, while reflected light (reflected light from a target or adjustment mirror 404) is received, light receiving unit 401 outputs an electrical signal indicating the amount of received light (the amount of received light) to received light amount acquisition unit 204. Received light amount acquisition unit 204 acquires the amount of received light by light receiving unit 401, based on the electrical signal. The amount of received light acquired by received light amount acquisition unit 204 is output to peak acquisition unit 208.

Peak acquisition unit 208 acquires information on output direction (the amount of drive) when the amount of received light by light receiving unit 401 reaches at least one of a peak or an inverse peak by driving mirror 402 in the optical axis deviation detection mode. Peak acquisition unit 208 may function as a detector that detects information on output direction. For detection of a peak in the horizontal direction, peak acquisition unit 208 determines that the amount of received light reaches a peak when the amount of received light is greater than a predetermined first threshold value. For detection of a peak in the vertical direction, peak acquisition unit 208 determines that the amount of received light reaches an inverse peak when the amount of received light is smaller than a predetermined second threshold value.

For a peak or an inverse peak, any other method may be performed. Peak acquisition unit 208 typically recognizes, as a peak of the amount of received light, the largest amount of received light in a period from when “an increase value in the amount of received light by driving of mirror 402 becomes a predetermined value or more” to “when a decrease value in the amount of received light becomes a predetermined value or more”. Peak acquisition unit 208 detects the amount of drive of mirror 402 at the time of the peak.

Peak acquisition unit 208 typically recognizes, as an inverse peak of the amount of received light, the smallest amount of received light in a period from when “a decrease value in the amount of received light by driving of mirror 402 becomes a predetermined value or more” to “when an increase value in the amount of received light becomes a predetermined value or more”. Peak acquisition unit 208 detects the amount of drive of mirror 402 at the time of the inverse peak.

In the present embodiment, as shown in FIG. 10, it is assumed that peak acquisition unit 208 acquires “−120” and “80” as the amount of drive of mirror 402 at the time of the peak and that peak acquisition unit 208 acquires “−10” as the amount of drive of mirror 402 at the time of the inverse peak.

Peak acquisition unit 208 outputs the amount of drive at the time of the peak and the amount of drive at the time of the inverse peak to first deviation amount detection unit 210.

Non-deviation peak storage unit 212 stores non-deviation peak information beforehand. The non-deviation peak information is information described with reference to FIG. 9. The non-deviation peak information is information indicating the amount of drive of mirror 402 at the time of a peak of the amount of received light and the amount of mirror 402 at the time of an inverse peak of the amount of received light in a case where an optical axis deviation is not occurring. The non-deviation peak information is information acquired by peak acquisition unit 208 in a case where an optical axis deviation is not occurring.

First deviation amount detection unit 210 detects the differential amount of drive in the horizontal direction, from the amount of drive in the horizontal direction of mirror 402 at the time of a peak acquired by peak acquisition unit 208 and the amount of drive in the horizontal direction of mirror 402 at the time of a peak in non-deviation peak information stored in non-deviation peak storage unit 212. In the example in FIG. 9 and FIG. 10, the differential amount of drive in the horizontal direction is “−20”. First deviation amount detection unit 210 coverts the differential amount of drive in the horizontal direction into the deviation angle Δθh in the horizontal direction, for example, using the correspondence table in FIG. 11.

First deviation amount detection unit 210 detects the differential amount of drive in the vertical direction, from the amount of drive in the vertical direction of mirror 402 at the time of a peak that is acquired by peak acquisition unit 208 and the amount of drive in the vertical direction of mirror 402 at the time of a peak in non-deviation peak information that is stored in non-deviation peak storage unit 212. In the example in FIG. 9 and FIG. 10, the differential amount of drive in the vertical direction is “−10”. First deviation amount detection unit 210 converts the differential amount of drive in the vertical direction into the deviation angle Δθv in the vertical direction, for example, using the correspondence table in FIG. 11. In this way, first deviation amount detection unit 210 detects the deviation angle Δθh in the horizontal direction and the deviation angle Δθv in the vertical direction, as a first optical axis deviation.

First deviation amount detection unit 210 transmits the first optical axis deviation (the deviation angle Δθh in the horizontal direction and the deviation angle Δθv in the vertical direction) to a not-shown high-level ECU (engine control unit) through a network circuit 230. First deviation amount detection unit 210 transmits the deviation angle Δθh in the horizontal direction and the deviation angle Δθv in the vertical direction to first deviation amount determination unit 214.

First deviation amount determination unit 214 determines whether the deviation angle Δθh in the horizontal direction and the deviation angle Δθv in the vertical direction each fall within a normal range. Threshold values that define the normal range are stored beforehand in first range storage unit 216. When it is determined that at least one of the deviation angle Δθh in the horizontal direction and the deviation angle Δθv in the vertical direction falls out of the normal range, first deviation amount determination unit 214 transmits a first determination signal indicating abnormality to the high-level ECU. When it is determined that both of the deviation angle Δθh in the horizontal direction and the deviation angle Δθv in the vertical direction fall within the normal range, first deviation amount determination unit 214 transmits a first determination signal indicating normality to the high-level ECU.

Second deviation detecting device 260 will now be described. During the optical axis deviation detection mode, the amount of received light acquired by received light amount acquisition unit 204 is output to outer shape information acquisition unit 220. Outer shape information acquisition unit 220 acquires outer shape information 600 (corresponding to FIG. 2(B)) indicating a part of the outer shape of movable body 101 by allowing driving of mirror 402 in a predetermined drive range. Outer shape information acquisition unit 220 generates outer shape information 600, for example, based on “the amount of received light by light receiving unit 401 (the quantity of reflected light from a target)”, “the time from when laser output unit 403 outputs laser light to when light receiving unit 401 receives light”, and “the amount of drive of mirror 402 (the output direction of reflected light from mirror 402)”.

Typically, outer shape information acquisition unit 220 generates outer shape information 600 by converting information such as “the amount of received light by light receiving unit 401 (the quantity of reflected light from a target)”, “the time from when laser output unit 403 outputs laser light to when light receiving unit 401 receives light”, and “the amount of drive of mirror 402 (the output direction of reflected light from mirror 402)” into dimensions in spatial axes.

Non-deviation outer shape information storage unit 224 stores non-deviation outer shape information 500 beforehand. Non-deviation outer shape information 500 is information described with reference to FIG. 12. Non-deviation outer shape information 500 is outer shape information indicating a part of the outer shape of movable body 101 in a case where an optical axis deviation is not occurring. Non-deviation outer shape information 500 is information acquired by outer shape information acquisition unit 220 in a case where an optical axis deviation is not occurring.

Second deviation amount detection unit 222 detects a second optical axis deviation amount, based on outer shape information 600 from outer shape information acquisition unit 220 and non-deviation outer shape information 500 stored in non-deviation outer shape information storage unit 224. Typically, second deviation amount detection unit 222 detects the deviation angle Δθh in the horizontal direction and the deviation angle Δθv in the vertical direction, as a second optical axis deviation.

Second deviation amount detection unit 222 transmits the second optical axis deviation (the deviation angle Δθh in the horizontal direction and the deviation angle Δθv in the vertical direction) to the not-shown high-level ECU through network circuit 230. Second deviation amount detection unit 222 transmits the deviation angle Δθh in the horizontal direction and the deviation angle Δθv in the vertical direction to second deviation amount determination unit 226.

Second deviation amount determination unit 226 determines whether the deviation angle Δθh in the horizontal direction and the deviation angle Δθv in the vertical direction each fall within a normal range. Threshold values that define the normal range are stored beforehand in second range storage unit 228. When it is determined that at least one of the deviation angle Δθh in the horizontal direction and the deviation angle Δθv in the vertical direction falls out of the normal range, second deviation amount determination unit 226 transmits a second determination signal indicating abnormality to the high-level ECU. When it is determined that both of the deviation angle Δθh in the horizontal direction and the deviation angle Δθv in the vertical direction fall within the normal range, second deviation amount determination unit 226 transmits a second determination signal indicating normality to the high-level ECU.

### FLOWCHART OF FIRST DEVIATION DETECTING DEVICE

FIG. 14 is a flowchart of a first deviation detection process by first deviation detecting device 250. First, at step S2, first deviation detecting device 250 determines whether a first start condition is met. The first start condition is a condition for starting the first deviation detection process by first deviation detecting device 250. The first start condition includes, for example, a condition that optical axis deviation detecting device 200 is powered on. At step S2, first deviation detecting device 250 waits until it is determined that the first start condition is met (NO at step S2).

At step S2, if first deviation detecting device 250 determines that the first start condition is met (YES at step S2), the process proceeds to step S4.

At step S4, mirror driver 206 drives mirror 402 by a predetermined offset amount in the vertical direction.

Here, the predetermined offset amount is described. For example, an optical axis deviation in the vertical direction is not occurring but an optical axis deviation in the horizontal direction is occurring in some cases. In this case, when mirror driver 206 detects an optical axis deviation in the horizontal direction during the optical axis deviation detection mode, the reflected light from mirror 402 passes through second middle region Y (see FIG. 8), and first deviation amount detection unit 210 is unable to detect a peak in the horizontal direction as shown in FIG. 10(A).

Then, in the present embodiment, mirror driver 206 drives mirror 402 in the vertical direction by a predetermined offset amount. This ensures that first deviation amount detection unit 210 detects a peak in the horizontal direction, irrespective of whether an optical axis deviation in the vertical direction is occurring.

The predetermined offset amount may be either a first offset amount or a second offset amount greater than the first offset amount. When optical axis deviation detecting device 200 employs the first offset amount, the drive time of mirror 402 in the vertical direction based on the first offset amount can be reduced, and therefore, the time required for detecting an optical axis deviation can be reduced.

When optical axis deviation detecting device 200 employs the second offset amount, the reflected light from mirror 402 can impinge on high reflection region 404A, irrespective of whether an optical axis deviation in the vertical direction is occurring and the degree of optical axis deviation in the vertical direction. First deviation amount detection unit 210 therefore can improve the accuracy in detection of a peak in the horizontal direction.

The first offset amount is, for example, the amount obtained by multiplying an upper limit value in the normal range stored in first range storage unit 216 by a predetermined multiple (for example, 5). The second offset amount is a value obtained by multiplying the drive angle in the vertical direction of mirror 402 by a predetermined number (for example, ½). In the present embodiment, as the drive angle is ±30 degrees, the second offset amount is the amount of drive equivalent to 15 degrees.

Subsequently, at step S6, mirror driver 206 performs driving in the horizontal direction by a minimum unit amount. This minimum unit amount is the amount based on the scan resolution of optical axis deviation detecting device 200. Subsequently, at step S8, received light amount acquisition unit 204 acquires the amount of received light and outputs the acquired amount of received light to peak acquisition unit 208. Every time the amount of received light is acquired, peak acquisition unit 208 compares the magnitude of the acquired amount of received light with a first threshold value to detect a peak (the presence or absence of a peak).

Subsequently, at step S10, first deviation detecting device 250 determines whether the driving is performed in the entire range in the horizontal direction. The driving in the entire range in the horizontal direction is typically the driving by which the output direction of reflected light from mirror 402 comes from direction d to direction b.

If the determination by first deviation detecting device 250 is NO at step S10, the process returns to step S6. If the determination by first deviation detecting device 250 is YES at step S10, the process proceeds to step S12.

At step S12, first deviation amount detection unit 210 detects a first optical axis deviation in the horizontal direction. This first optical axis deviation in the horizontal direction is temporarily stored in a predetermined storage area.

Subsequently, at step S14, mirror driver 206 drives mirror 402 to a position where the amount of received light reaches a peak in the horizontal direction. Here, the position where the amount of received light reaches a peak is specified from the process result at step S8. In the example in FIG. 10, the position where the amount of received light reaches a peak is the position where the amount of drive of mirror 402 is “−120” or the position where the amount of drive of mirror 402 is “80”. As a modification, a position where the amount of received light reaches a peak in non-deviation peak information may be used. In the example in FIG. 9, the position where the amount of received light reaches a peak is the position where the amount of drive of mirror 402 is “−100” or the position where the amount of drive of mirror 402 is “100”. This process at step S14 ensures that reflected light from mirror 402 impinges on the high reflection region when mirror driver 206 drives mirror 402 in the vertical direction.

Subsequently, received light amount acquisition unit 204 acquires the amount of received light and outputs the acquired amount of received light to peak acquisition unit 208. Every time the amount of received light is acquired, peak acquisition unit 208 compares the magnitude of the acquired amount of received light with a second threshold value to detect an inverse peak (the presence or absence of an inverse peak). At step S20, first deviation detecting device 250 determines whether the driving is performed in the entire range in the vertical direction. The driving in the entire range in the vertical direction is typically ±30 degrees.

If the determination by first deviation detecting device 250 is NO at step S20, the process returns to step S16. If the determination by first deviation detecting device 250 is YES at step S20, the process proceeds to step S22.

Subsequently, at step S22, first deviation amount detection unit 210 detects a first optical axis deviation in the vertical direction. This first optical axis deviation in the vertical direction is temporarily stored in a predetermined storage area.

Subsequently, at step S24, first deviation amount determination unit 214 determines whether the deviation angle Δθh in the horizontal direction and the deviation angle Δθv in the vertical direction each fall within a normal range. At step S24, if first deviation amount determination unit 214 determines that the deviation angle Δθh in the horizontal direction and the deviation angle Δθv in the vertical direction each fall within a normal range (YES at step S24), the process proceeds to step S26.

If first deviation amount determination unit 214 determines that at least one of the deviation angle Δθh in the horizontal direction and the deviation angle Δθv in the vertical direction does not fall within a normal range (NO at step S24), the process proceeds to step S30.

At step S30, first deviation amount determination unit 214 transmits an abnormality signal as a first determination signal to the high-level ECU. At step S26, first deviation detecting device 250 determines whether an update mode is set. The update mode is a mode, for example, used in assembly in a manufacturing process of movable body 101. If the determination at step S26 is YES, the process proceeds to step S28.

At step S28, first deviation detecting device 250 changes (updates) reference direction M so as to eliminate the detected optical axis deviation amount. If the determination at step S26 is NO, or if the process at step S28 ends, or if the process at step S30 ends, the first deviation amount detection process is terminated.

### FLOWCHART OF SECOND DEVIATION DETECTING DEVICE

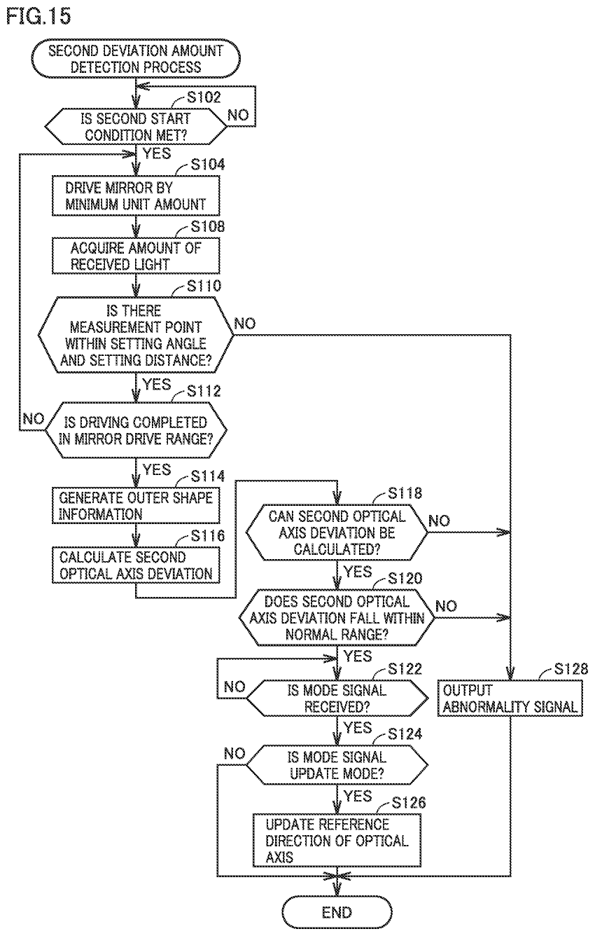

FIG. 15 is a flowchart of a second deviation detection process by second deviation detecting device 260. First, at step S102, first deviation detecting device 250 determines whether a second start condition is met. The second start condition is a condition for starting the second deviation detection process by second deviation detecting device 260. The second start condition includes, for example, a condition that is met when optical axis deviation detecting device 200 is powered on. The second start condition includes at least one of: a condition that an instruction signal from the high-level ECU is input to second deviation detecting device 260; a condition that optical axis deviation detecting device 200 is powered on; and a condition that the controlled driving assistance mode is turned off The first start condition and the second start condition may be identical or may be different. In a case where the first start condition and the second start condition are the identical condition, when the identical condition is met, optical axis deviation detecting device 200 may execute one of the first deviation detection process and the second deviation detection process first and execute the other later.

Subsequently, at step S104, mirror driver 206 drives mirror 402 by a minimum unit amount. Mirror 402 is driven at step S104 by the minimum unit amount in one of the horizontal direction and the vertical direction. Mirror driver 206 repeats the process at step S104 until the determination is YES at step S112. That is, at step S104, mirror driver 206 drives mirror 402 in a predetermined order (changes the output direction of reflected light from mirror 402) so that ultimately mirror 402 is driven in the entire drive range.

Subsequently, at step S108, received light amount acquisition unit 204 acquires the amount of received light. Subsequently, at step S110, second deviation detecting device 260 determines whether a measurement point exists within a setting angle and a setting distance. Here, the process at step S110 determines whether received light amount acquisition unit 204 has acquired the amount of received light appropriately at step S108 within the setting angle defined at step S104 and a predetermined setting distance.

If the determination is NO at step S110, the process proceeds to step S128. At step S128, second deviation detecting device 260 outputs an abnormality signal to the high-level ECU. This abnormality signal is a signal indicating that the amount of received light has failed to be acquired appropriately at step S110.

On the other hand, if the determination is YES at step S110, the process proceeds to step S112. At step S112, second deviation detecting device 260 determines whether the driving has been completed within the entire drive range of mirror 402.

If the determination at step S112 is NO, the process proceeds to step S104. If the determination at step S112 is YES, the process proceeds to step S114. At step S114, outer shape information acquisition unit 220 generates and acquires outer shape information, based on the amount of received light within the entire drive range of mirror 402. Subsequently, at step S116, second deviation amount detection unit 222 calculates a second optical axis deviation amount, based on outer shape information 600 from outer shape information acquisition unit 220 and non-deviation outer shape information 500 stored in non-deviation outer shape information storage unit 224.

Subsequently, at step S118, second deviation amount detection unit 222 determines whether the second optical axis deviation amount can be calculated. Second deviation amount detection unit 222 is unable to calculate the second optical axis deviation amount, for example, when outer shape information acquisition unit 220 fails to generate outer shape information appropriately at step S114.

If the determination at step S118 is NO, the process proceeds to step S128. At step S128, second deviation detecting device 260 outputs an abnormality signal to the high-level ECU. This abnormality signal is a signal indicating that outer shape information has failed to be generated appropriately at step S114.

If the determination at step S118 is YES, the process proceeds to step S120. At step S120, second deviation amount determination unit 226 determines whether the second optical axis deviation amount falls within a normal range, based on a second threshold value stored in second range storage unit 228.

If the determination at step S120 is NO, the process proceeds to step S128. At step S128, second deviation amount determination unit 226 outputs an abnormality signal to the high-level ECU. This abnormality signal is a signal indicating that the second optical axis deviation amount does not fall within a normal range.

If the determination at step S120 is YES, the process proceeds to step S122. At step S122, second deviation detecting device 260 waits, for example, until a mode signal is transmitted from the high-level ECU (NO at step S122). If the determination at step S122 is YES, the process proceeds to step S124.

At step S124, second deviation detecting device 260 determines whether the mode signal is a signal indicating the update mode. If the determination at step S124 is YES, the process proceeds to step S126. If the determination at step S124 is NO, the second deviation amount detection process is terminated. The process at step S126 is the same as step S28 in FIG. 14.

In the present embodiment, the first optical axis deviation detected by first deviation detecting device 250 is typically information indicating abnormality of output unit 410 of target detection device 900. The second optical axis deviation detected by second deviation detecting device 260 is typically information indicating abnormality of the attachment position of target detection device 900 to movable body 101. In this way, in the present embodiment, the first optical axis deviation and the second optical axis deviation are different in concept. As a modification, the first optical axis deviation and the second optical axis deviation may be the same concept. For example, the first optical axis deviation and the second optical axis deviation may be information indicating abnormality of output unit 410 of target detection device 900.

When first deviation detecting device 250 detects a first optical axis deviation and when second deviation detecting device 260 detects a second optical axis deviation, in both cases, reference direction M of mirror 402 is updated so as to eliminate the optical axis deviation (see step S28 and step S126).

In at least one of the case where first deviation detecting device 250 detects a first optical axis deviation and the case where second deviation detecting device 260 detects a second optical axis deviation, optical axis deviation detecting device 200 may output prompt information to prompt the user (for example, the operator of movable body 101) for “repair at a maintenance company since an optical axis deviation has been detected”.

### PRIMARY ADVANTAGEOUS EFFECT ACHIEVED BY OPTICAL AXIS DEVIATION DETECTING DEVICE IN THE PRESENT EMBODIMENT

The primary advantageous effect achieved by optical axis deviation detecting device 200 in the present embodiment will now be described.

(1) Non-deviation peak information is stored beforehand in non-deviation peak storage unit 212 of optical axis deviation detecting device 200 in the present embodiment. As shown in FIG. 1(C) and FIG. 9, the non-deviation peak information is information indicating the amount of drive of mirror 402 (the output direction of mirror 402) at the time of a peak of the amount of received light from adjustment mirror 404 and the amount of drive of mirror 402 (the output direction of mirror 402) at the time of an inverse peak of the amount of received light from adjustment mirror 404, in a case where an optical axis deviation is not occurring.

During the optical axis deviation detection mode, as shown in FIG. 1(D) and FIG. 10, peak acquisition unit 208 drives mirror 402 in the same manner as when non- deviation peak information is generated (the method for acquiring a drive range of mirror 402 and a peak or an inverse peak (for example, an acquisition program)). Peak acquisition unit 208 thus acquires the amount of drive when the amount of received light by light receiving unit 401 from adjustment mirror 404 reaches a peak and an inverse peak (the output direction of mirror 402).

First deviation amount detection unit 210 detects a first optical axis deviation, based on the amount of drive in non-deviation peak information stored beforehand in non-deviation peak storage unit 212 and the amount of drive acquired by peak acquisition unit 208.

In this way, optical axis deviation detecting device 200 detects an optical axis deviation of output unit 410, using adjustment mirror 404 included in movable body 101 (optical axis deviation detecting device 200). Therefore, unlike PTL 1, optical axis deviation detecting device 200 detects an optical axis deviation without moving movable body 101 to the place where the target board is installed. Optical axis deviation detecting device 200 therefore can detect an optical axis deviation without imposing a burden on the user.

(2) As described with reference to FIG. 6, two adjustment mirrors 404 are arranged at positions where the reflected light from mirror 402 is reflected when driving is performed in the second drive range. The second drive range is a range different from the range in which mirror 402 is driven during the driving assistance mode. Optical axis deviation detecting device 200 therefore can prevent target detection during the driving assistance mode from being interrupted by adjustment mirror 404.

(3) As described with reference to FIG. 7 and FIG. 8, high reflection region 404A of reflection region 404a is first middle region X of the midsection along the first direction (vertical direction), excluding second middle region Y of the midsection along the horizontal direction. Low reflection region 404B of reflection region 404a is second middle region Y and a region other than first middle region X.

Because of such a configuration of reflection region 404a, peak acquisition unit 208 can acquire a peak appropriately for the horizontal direction and the vertical direction.

(4) At step S4 in FIG. 14, mirror driver 206 drives mirror 402 in the vertical direction by the offset amount. This can ensure that reflected light from mirror 402 impinges on high reflection region 404A, irrespective of whether an optical axis deviation in the vertical direction is occurring. In other words, peak acquisition unit 208 ensures acquisition of a peak in the horizontal direction, irrespective of whether an optical axis deviation in the vertical direction is occurring.

(5) Supposing that adjustment mirror 404 is provided at the midsection in the drive range in the horizontal direction of mirror 402 (in the vicinity of reference direction M), optical axis deviation detecting device 200 is unable to detect an optical axis deviation in the horizontal direction appropriately. Then, in the present embodiment, as shown in FIG. 6, left-side adjustment mirror 404L and right-side adjustment mirror 404R are provided at both ends in the drive range in the horizontal direction of mirror 402. Optical axis deviation detecting device 200 therefore can detect an optical axis deviation in the horizontal direction appropriately.

(6) Non-deviation outer shape information 500 is stored beforehand in non-deviation outer shape information storage unit 224 of optical axis deviation detecting device 200 in the present embodiment. As shown in FIG. 2(A) and FIG. 12, non-deviation outer shape information 500 is outer shape information indicating a part of the outer shape of movable body 101 in a case where an optical axis deviation is not occurring.

As show in in FIG. 2(B) and FIG. 12, during the optical axis deviation detection mode, outer shape information acquisition unit 220 acquires outer shape information by driving mirror 402 in the same manner of driving as when non-deviation outer shape information 500 is generated.

Second deviation amount detection unit 222 detects a second optical axis deviation, based on the amount of drive in non-deviation outer shape information stored beforehand in non-deviation outer shape information storage unit 224 and the outer shape information acquired by peak acquisition unit 208.

In this way, optical axis deviation detecting device 200 detects an optical axis deviation of output unit 410, using the outer shape of movable body 101. Therefore, unlike PTL 1, optical axis deviation detecting device 200 detects an optical axis deviation without moving movable body 101 to the place where the target board is installed. Optical axis deviation detecting device 200 therefore can detect an optical axis deviation without imposing a burden on the user.

### Second Embodiment

The foregoing first embodiment is based on the premise that when the vertical direction is fixed and mirror 402 is driven in the horizontal direction, mirror 402 is driven along the horizontal direction appropriately although an optical axis deviation in the horizontal direction may occur. Furthermore, the foregoing first embodiment is based on the premise that when the horizontal direction is fixed and mirror 402 is driven in the vertical direction, mirror 402 is driven along the vertical direction appropriately although an optical axis deviation in the vertical direction may occur. Hereinafter, such a premise is referred to as “linearity is ensured”.

In the present embodiment, an embodiment in which linearity is not ensured will be described. That is, in the present embodiment, when the vertical direction is fixed and mirror 402 is driven in the horizontal direction, it may be driven with a skew from the horizontal direction (in a direction deviating from the horizontal direction). In the present embodiment, when the horizontal direction is fixed and mirror 402 is driven in the vertical direction, mirror 402 may be driven with a skew from the vertical direction (in a direction deviating from the vertical direction). Optical axis deviation detecting device 200 in the present embodiment detects an optical axis deviation that causes these cases (hereinafter referred to as “third optical axis deviation”). The third optical axis deviation is an optical axis deviation that distorts linearity.

Optical axis deviation detecting device 200 in the present embodiment uses an adjustment mirror 802 different from adjustment mirror 404 in the first embodiment.

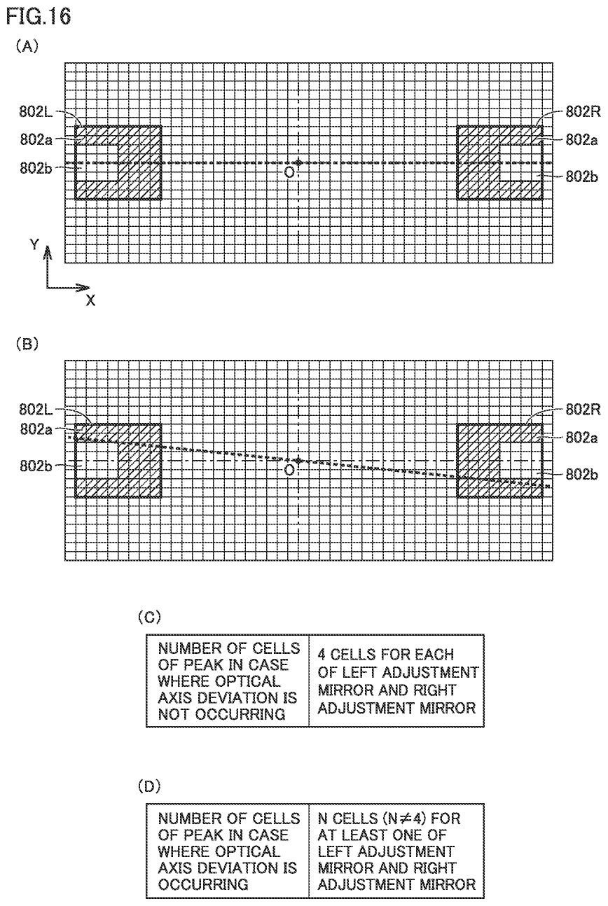

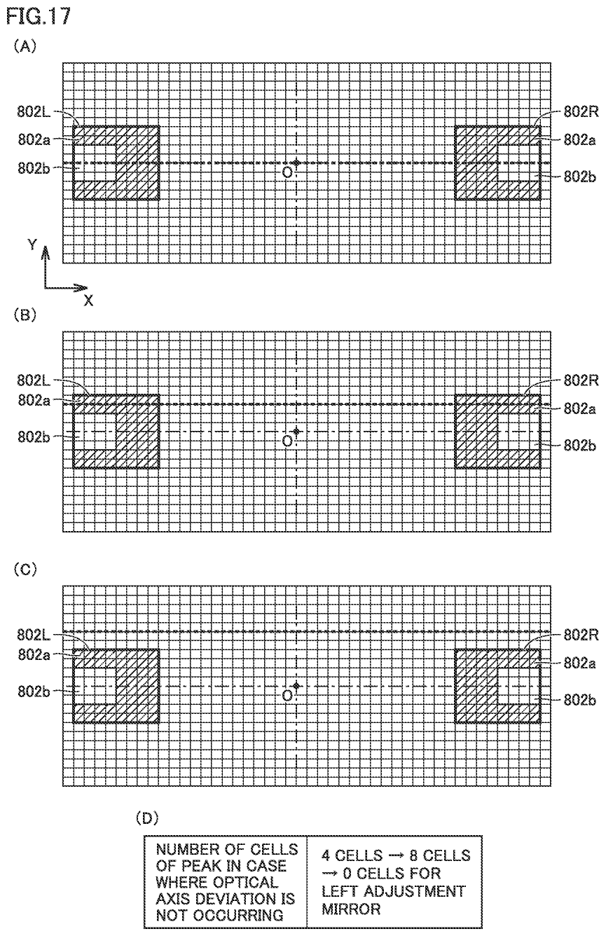

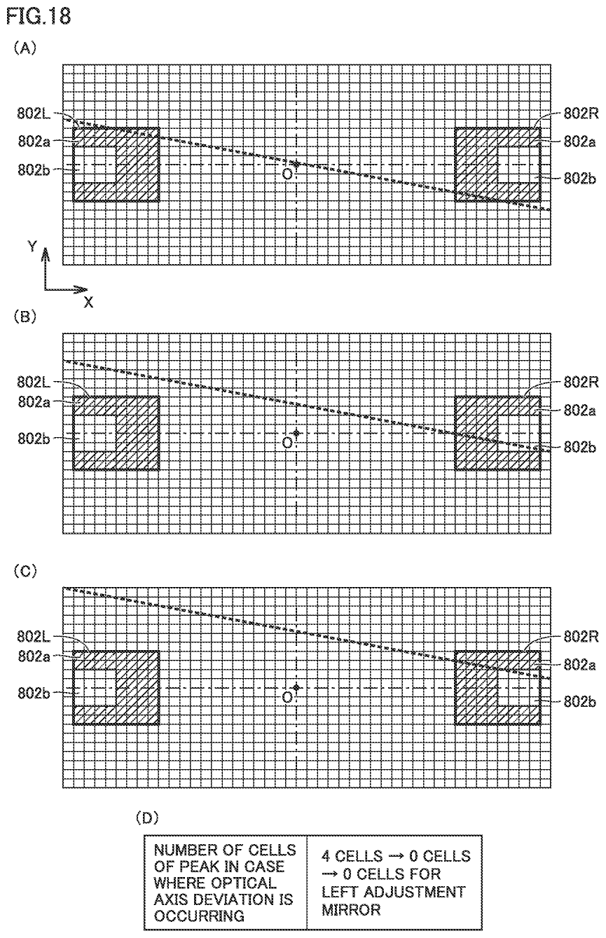

FIG. 16 is a diagram showing a reflection region of adjustment mirror 802 in the present embodiment. In FIG. 16, adjustment mirror 802 is shown by a bold line. Adjustment mirror 802 includes a right-side adjustment mirror 802R and a left-side adjustment mirror 802L. Right-side adjustment mirror 802R and left-side adjustment mirror 802L are installed, for example, in place of right-side adjustment mirror 404R and left-side adjustment mirror 404L in FIG. 6. That is, right-side adjustment mirror 802R and left-side adjustment mirror 802L are provided at both ends in the horizontal direction (one drive direction) of mirror 402. In FIG. 16, and FIG. 17 and FIG. 18 described later, cells are illustrated for ease of explanation.

As shown in FIG. 16(A), the reflection region of right-side adjustment mirror 802R includes a hatched high reflection region 802a and a low reflection region 802b. Similarly, the reflection region of left-side adjustment mirror 802L also includes a hatched high reflection region 802a and a low reflection region 802b. The cells in FIG. 16 correspond to the resolution of mirror 402. That is, for example, when mirror 402 is driven by a minimum unit amount in the horizontal direction, reflected light from mirror 402 moves by one cell in the horizontal direction.

As shown in FIG. 16(A), in right-side adjustment mirror 802R and left-side adjustment mirror 802L, low reflection region 802b and high reflection region 802a are symmetric between right-side adjustment mirror 802R and left-side adjustment mirror 802L with respect to the midsection (the origin O in FIG. 16) in the drive range in the horizontal direction (which may be referred to as one drive direction or a third direction).

That is, low reflection region 802b of right-side adjustment mirror 802R and low reflection region 802b of left-side adjustment mirror 802L are symmetric with respect to the origin O. Further, high reflection region 802a of right-side adjustment mirror 802R and high reflection region 802a of left-side adjustment mirror 802L are symmetric with respect to the origin O.

If mirror 402 is driven in the horizontal direction (third direction) in a drive range such that reflected light from mirror 402 impinges on both of right-side adjustment mirror 802R and left-side adjustment mirror 802L in a case where a third optical axis deviation is not occurring, the trajectory of points irradiated with the reflected light from mirror 402 is as shown by the dotted line in the horizontal direction in FIG. 16(A). FIG. 16(B) shows the trajectory of points irradiated with the reflected light from mirror 402 when mirror 402 is driven in the horizontal direction in a case where a third optical axis deviation is occurring.

As shown in FIG. 16(B), when mirror driver 206 drives mirror 402 in the horizontal direction (third direction) in a case where a third optical axis deviation is occurring, the trajectory of points irradiated with the reflected light from mirror 402 extends not in the horizontal direction as depicted by the broken line in FIG. 16(A) but in a direction deviating from the horizontal direction (the direction depicted by the broke line in FIG. 16(B)).

In the present embodiment, first deviation detecting device 250 includes a storage unit, an acquisition unit, and a detection unit (they are not shown in the figure) as a device for detecting a third optical axis deviation. The storage unit of optical axis deviation detecting device 200 in the present embodiment stores the amount of drive at which the amount of received light by light receiving unit 401 reaches a peak in a case where a third optical axis deviation is not occurring. The amount of drive is information acquired by the acquisition unit in a case where a third optical axis deviation is not occurring. The stored amount of drive may be referred to as “information on the amount of drive” or may simply referred to as “the amount of drive”. The “peak” refers to the amount of received light when reflected light by mirror 402 is reflected by high reflection region 802a. In the example in FIG. 16, one minimum unit amount is referred to as “one cell”, and this minimum unit amount (the number of cells) may be referred to as “the amount of drive”. Hereinafter, “the amount of drive at which the amount of received light by light receiving unit 401 reaches a peak in a case where a third optical axis deviation is not occurring” is referred to as “the amount of non-deviation drive”. Information concerning the amount of non-deviation drive is referred to as “the amount of non-deviation drive information (first storage information)”.

FIG. 16(C) is a diagram showing the amount of non-deviation drive information in text. A predetermined number of cells (the amount of drive of the minimum unit amount) is defined as the amount of non-deviation drive, for left-side adjustment mirror 802L and right-side adjustment mirror 802R. In the example in FIG. 16(C), a predetermined number of cells is defined as four cells (the amount of drive of four minimum unit amounts). This is based on that the number of cells of high reflection region 802a is “4” for both of left-side adjustment mirror 802L and right-side adjustment mirror 802R, as shown by the broken line passing through the origin O (the amount of drive in the vertical direction is zero) in FIG. 16(A).

The amount of non-deviation drive information is acquired by the acquisition unit when mirror driver 206 drives mirror 402 in the horizontal direction while the vertical direction is fixed in a case where an optical axis deviation (third optical axis deviation) is not occurring. The amount of non-deviation drive information is information acquired and stored beforehand, for example, at the time of manufacture of optical axis deviation detecting device 200 (target detection device 900).

The process during the optical axis deviation detection mode will now be described. During the optical axis deviation detection mode, mirror driver 206 drives mirror 402 in the same manner of driving as when the amount of non-deviation drive information is generated.

FIG. 16(D) shows the number of cells (the amount of drive) at the time (period of time) of a peak acquired by peak acquisition unit 208 during the optical axis deviation detection mode. The acquired amount of drive may be referred to as “information on the amount of drive (first acquired information)” or may be simply referred to as “the amount of drive”. In a case where a third optical axis deviation as shown in FIG. 16(B) is occurring, the amount of drive at the peak in at least one of left-side adjustment mirror 802L and right-side adjustment mirror 802R is N cells. Here, in a case where a third optical axis deviation is not occurring, N≠4 in at least one of left-side adjustment mirror 802L and right-side adjustment mirror 802R.

That is, during the optical axis deviation detection mode, in a case where a third optical axis deviation is occurring, the number of cells when the amount of received light reaches a peak is different from the number of cells (in the present embodiment, four) defined by the amount of non-deviation drive information.

In the example in FIG. 16(B), the amount of drive at the peak is “8” in both of left-side adjustment mirror 802L and right-side adjustment mirror 802R.

Optical axis deviation detecting device 200 in the present embodiment can detect a third optical axis deviation that distorts linearity in the drive direction of mirror 402. In the optical axis deviation detection mode, the acquisition unit of optical axis deviation detecting device 200 acquires information on the amount of drive (first acquisition information) at which the amount of received light by the light receiving unit reaches a peak when the output unit performs driving in the third direction (horizontal direction). On the other hand, the storage unit of optical axis deviation detecting device 200 stores first storage information (the amount of non-deviation drive information) on the amount of drive at which the amount of received light by the light receiving unit reaches a peak that is acquired when the output unit performs driving in the third direction (horizontal direction) in a case where an optical deviation is not occurring. Then, the detection unit of optical axis deviation detecting device 200 detects an optical axis deviation (third optical axis deviation), based on first acquisition information on the acquired amount of drive (the amount of drive at the time of a peak of the amount of received light) and first storage information on the amount of drive that is stored in the storage unit. Typically, optical axis deviation detecting device 200 drives mirror 402 in the horizontal direction in a drive range in which reflected light from mirror 402 impinges on both of right-side adjustment mirror 802R and left-side adjustment mirror 802L. With this driving, optical axis deviation detecting device 200 acquires the amount of drive (the number of cells) when the amount of received light reaches a peak. Furthermore, optical axis deviation detecting device 200 determines whether the acquired amount of drive is identical to the amount of non-deviation drive (four cells). Optical axis deviation detecting device 200 determines that a third optical axis deviation is not occurring when the amount of drive at the time of a peak of the amount of received light is identical to the amount of non-deviation drive for both of right-side adjustment mirror 802R and left-side adjustment mirror 802L. On the other hand, optical axis deviation detecting device 200 determines that a third optical axis deviation is occurring when the amount of drive at the time of a peak of the amount of received light is different from the amount of non-deviation drive for at least one of right-side adjustment mirror 802R and left-side adjustment mirror 802L. The case where optical axis deviation detecting device 200 determines that the amount of drive at the time of a peak of the amount of received light is different from the amount of non-deviation drive for at least one of right-side adjustment mirror 802R and left-side adjustment mirror 802L includes the following first to third cases. The first case is a case where the amount of drive at the time of a peak of the amount of received light is different from the amount of non-deviation drive, for right-side adjustment mirror 802R. The second case is a case where the amount of drive at the time of a peak of the amount of received light is different from the amount of non-deviation drive, for left-side adjustment mirror 802L. The third case is a case where the amount of drive at the time of a peak of the amount of received light is different from the amount of non-deviation drive, for both of right-side adjustment mirror 802R and left-side adjustment mirror 802L.

Optical axis deviation detecting device 200 in the present embodiment detects an optical axis deviation of output unit 410 (third optical deviation), using adjustment mirror 802 included in movable body 101 (optical axis deviation detecting device 200). Therefore, unlike PTL 1, optical axis deviation detecting device 200 detects an optical axis deviation without moving movable body 101 to the place where the target board is installed. Optical axis deviation detecting device 200 therefore can detect an optical axis deviation without imposing a burden on the user.

A modification to the second embodiment will now be described. The storage unit in the second embodiment may store beforehand at least one of the amount of drive at which the amount of received light by light receiving unit 401 reaches a peak in a case where an optical axis deviation is not occurring and the amount of drive at which the amount of received light by light receiving unit 401 reaches an inverse peak in a case where an optical axis deviation is not occurring. When such a configuration is employed, the acquisition unit (peak acquisition unit 208) may acquire the amount of drive at which the amount of received light by light receiving unit 401 reaches at least one of a peak and an inverse peak by driving mirror 402, in the optical axis deviation detection mode. The detection unit may detect an optical axis deviation, based on the amount of drive acquired by the acquisition unit and the amount of drive stored in the storage unit.

The idea of the second embodiment may be applied to the idea of the first embodiment. For example, in the horizontal direction in FIG. 6, adjustment mirror 802R and adjustment mirror 802L may be provided in the second drive range and on the outside or the inside of adjustment mirror 404R and adjustment mirror 404L, respectively. The optical axis deviation detecting device having such a configuration can detect both of a first optical axis deviation and a third optical axis deviation.

As shown in FIG. 16, optical axis deviation detecting device 200 includes two adjustment mirrors 802. However, the number of adjustment mirrors 802 may be one or three or more.

### Third Embodiment

A third embodiment will now be described. In the second embodiment, as illustrated in FIG. 16(D), in a case where a third optical axis deviation is not occurring, the amount of drive at the peak is the amount of non-deviation drive (in the example in FIG. 16, the amount of drive corresponding to four cells). However, even in a case where a third optical axis deviation is occurring, the amount of drive at the peak is the amount of non-deviation drive in some cases.

FIG. 18(A) is a diagram showing a case where the amount of drive at the peak is the amount of non-deviation drive (the amount of drive equivalent to four cells) when a third optical axis deviation is occurring. As shown in FIG. 18(A), even in a case where a third optical axis deviation is occurring, the amount of drive at the peak is the amount of non-deviation drive (the amount of drive equivalent to four cells). Rather than the third optical axis deviation shown in FIG. 18(A), a third optical axis deviation in which the amount of drive at the peak is the amount of non-deviation drive may occur, depending on the arrangement of left-side adjustment mirror 802L and right-side adjustment mirror 802R and the size of cells (the size of the minimum unit amount).

Then, in the third embodiment, a method of detecting a third optical axis deviation that may occur even when the amount of drive at the peak is the amount of non-deviation drive as described above will be described. In the following, the process described in the second embodiment is referred to as “specific process”.

The storage unit of optical axis deviation detecting device 200 stores beforehand second storage information (the amount of non-deviation drive information) on the amount of drive at which the amount of received light by the light receiving unit reaches a peak that is acquired by the acquisition unit when mirror 402 is driven in the third direction (horizontal direction) after mirror 402 is driven by a first amount in a fourth direction in a case where an optical deviation is not occurring (for example, at the time of manufacture of optical axis deviation detecting device 200). Here, the fourth direction is typically a direction different from the third direction, and the fourth direction is a direction parallel to the Y axis or a direction vertical to the third direction.

The storage unit of optical axis deviation detecting device 200 stores beforehand third storage information (the amount of non-deviation drive information) on the amount of drive at which the amount of received light by the light receiving unit reaches a peak that is acquired by the acquisition unit when mirror 402 is driven in the third direction (horizontal direction) after mirror 402 is further driven by a second amount in the fourth direction (vertical direction) in a case where an optical deviation is not occurring.

In this way, the storage unit of optical axis deviation detecting device 200 stores the first storage information, the second storage information, and the third storage information.

Even when optical axis deviation detecting device 200 determines that the amount of drive (first acquisition information) acquired by the acquisition unit is identical to the amount of non-deviation drive (first storage information) stored in the storage unit, through execution of the specific process, during the optical axis deviation detection mode, a third optical axis deviation as shown in FIG. 18(A) may occur in some cases. Then, optical axis deviation detecting device 200 in the present embodiment performs a second specific process in a state in which mirror 402 is driven in the fourth direction by the first amount. That is, optical axis deviation detecting device 200 acquires second acquisition information on the amount of drive (the number of cells) when the amount of received light reaches a peak by driving mirror 402 in the third direction (horizontal direction) in a state in which mirror 402 is driven in the fourth direction by the first amount.

After performing the second specific process, optical axis deviation detecting device 200 further drives mirror 402 in the fourth direction by the second amount. Subsequently, optical axis deviation detecting device 200 performs a third specific process. That is, optical axis deviation detecting device 200 drives mirror 402 in the third direction (horizontal direction) to acquire third acquisition information on the amount of drive (the number of cells) at the time of a peak of the amount of received light.

In the following, the first to third storage information may be collectively referred to as storage information. The first to third acquisition information may be collectively referred to as acquisition information.

When it is determined that the second acquisition information and the second storage information are identical and the third acquisition information and the third storage information are identical, optical axis deviation detecting device 200 determines that a third optical axis deviation is not occurring.

On the other hand, in at least one of a case where it is determined that the second acquisition information is different from the second storage information and a case where the third acquisition information is different from the third storage information, the detection unit of optical axis deviation detecting device 200 determines that a third optical axis deviation is occurring.

FIG. 17 and FIG. 18 are diagrams for explaining the present embodiment. FIG. 17 is a diagram showing a case where a third optical axis deviation is not occurring, and FIG. 18 shows a case where a third optical axis deviation is occurring. In the example in FIG. 17 and FIG. 18, the first storage information, the second storage information, and the third storage information for left-side adjustment mirror 802L are “4 cells”, “8 cells”, and “0 cells”, respectively. In the example in FIG. 17 and FIG. 18, it is assumed that both of the first amount and the second amount are “3 cells”. In the present embodiment, the acquisition information and the storage information for left-side adjustment mirror 802L are used, and the acquisition information and the storage information for right-side adjustment mirror 802R are not used.

FIG. 17(A) is the same diagram as FIG. 16(A). FIG. 17(A) to FIG. 17(C) are diagrams showing the first specific process, the second specific process, and the third specific process, respectively, in a case where a third optical axis deviation is not occurring. As shown in FIG. 17(D), in the first specific process, the second specific process, and the third specific process, the first acquisition information, the second acquisition information, and the third acquisition information for left-side adjustment mirror 802L are “4 cells”, “8 cells”, and “0 cells”, respectively. The second acquisition information and the third acquisition information therefore identical to the second storage information and the third storage information, respectively. Thus, optical axis deviation detecting device 200 determines that a third optical axis deviation is not occurring.

FIG. 18(A) to FIG. 18(C) are diagrams showing the first specific process, the second specific process, and the third specific process, respectively, in a case where a third optical axis deviation is occurring. As shown in FIG. 18(D), in the first specific process, the second specific process, and the third specific process, the first acquisition information, the second acquisition information, and the third acquisition information for left-side adjustment mirror 802L are “4 cells”, “0 cells”, and “0 cells”, respectively. The second acquisition information is therefore different from the second storage information. Therefore, optical axis deviation detecting device 200 determines that a third optical axis deviation is occurring.

According to the present embodiment, optical axis deviation detecting device 200 can detect even a third optical axis deviation as shown in FIG. 18(A).

In the present embodiment, optical axis deviation detecting device 200 performs the specific process three times. However, the specific process may be performed twice or four or more times.

Optical axis deviation detecting device 200 in the present embodiment uses the second storage information and the second acquisition information for left-side adjustment mirror 802L. However, optical axis deviation detecting device 200 may use the second storage information and the second acquisition information for both of left-side adjustment mirror 802L and right-side adjustment mirror 802R.

Optical axis deviation detecting device 200 in the present embodiment uses the amount of drive at the peak for left-side adjustment mirror 802L. However, optical axis deviation detecting device 200 may use the amount of drive at the inverse peak for left-side adjustment mirror 802L.

The third direction may be identical to one of the first direction and the second direction described above or may be different from either of the first direction and the second direction. The fourth direction may be identical to one of the first direction and the second direction described above or may be different from either of the first direction and the second direction.

### MODIFICATIONS

(1) In the example in FIG. 6, left-side adjustment mirror 404L and right-side adjustment mirror 404R are provided at both ends in the drive range in the horizontal direction of mirror 402. In the present modification, an example in which two adjustment mirrors are provided at both ends in the drive range in the vertical direction of mirror 402 will be described.

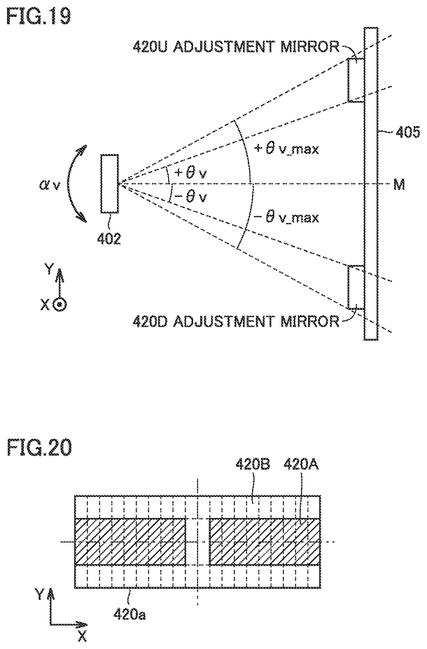

FIG. 19 shows an upper-side adjustment mirror 420U and a lower-side adjustment mirror 420D as two adjustment mirrors. In the following, upper-side adjustment mirror 420U and lower-side adjustment mirror 420D may be collectively referred to as adjustment mirror 420.

As previously described, mirror 402 can be driven even in the vertical direction Δv (Y-axis direction), for example, can be driven in ±30 degrees. Upper-side adjustment mirror 420U and lower-side adjustment mirror 420D are provided at both ends in the drive range in the vertical direction of mirror 402. Upper-side adjustment mirror 420U and lower-side adjustment mirror 420D are provided at cover 405.

The first drive range in the present modification is a range from “the direction in which the angle between the output direction (reflection direction) of reflected light from mirror 402 and reference direction M is −θv” to “the direction in which the angle between the output direction (reflection direction) of reflected light from mirror 402 and reference direction M is +θv”.

The second drive range includes a range from “the direction in which the angle between the output direction (reflection direction) of reflected light from mirror 402 and reference direction M is −θv_max” to “the direction in which the angle between the output direction (reflection direction) of reflected light from mirror 402 and reference direction M is −θv” and a range from “the direction in which the angle between the output direction (reflection direction) of reflected light from mirror 402 and reference direction M is +θv_max” to “the direction in which the angle between the output direction (reflection direction) of reflected light from mirror 402 and reference direction M is +θv”.

FIG. 20 is a diagram showing reflection region 420a of adjustment mirror 420. FIG. 20 is a diagram in which FIG. 7 is rotated clockwise or counterclockwise by 90 degrees. Reflection region 404a includes a high reflection region 420A and a low reflection region 420B.

For example, when movable body 101 is a vehicle, the vehicle usually runs along the horizontal direction. It is therefore preferable that, for mirror 402 provided in movable body 101 (vehicle), the drive range in the horizontal direction is wider than the drive range in the vertical direction. Therefore, as shown in FIG. 6, it is effective to arrange adjustment mirror 404 along the horizontal direction.

On the other hand, for example, when movable body 101 is a flying object, it can fly in both of the horizontal direction and the vertical direction. Then, it is preferable that, for mirror 402 provided in movable body 101 (flying object), the drive range in the horizontal direction and the drive range in the vertical direction are identical. Therefore, for example, when movable body 101 is a flying object, it is preferable that optical axis deviation detecting device 200 includes two adjustment mirrors 404 arranged along the horizontal direction and two adjustment mirrors 420 arranged along the vertical direction. This configuration can further increase the detection accuracy for an optical axis deviation in the horizontal direction and for an optical axis deviation in the vertical direction.

As another modification to the present modification, optical axis deviation detecting device 200 may include two adjustment mirrors 420 arranged along the vertical direction, rather than include two adjustment mirrors 404 arranged along the horizontal direction.

As another modification to the present modification, optical axis deviation detecting device 200 may apply the idea in FIG. 16 to the idea in FIG. 19. That is, two adjustment mirrors 802 rotated clockwise or counterclockwise by 90 degrees may be arranged in the vertical direction.

(2) Non-deviation peak storage unit 212 in the first embodiment stores both of: the amount of drive (output direction) at which the amount of received light by light receiving unit 401 reaches a peak based on reflection by the high reflection region in a case where an optical axis deviation is not occurring; and the amount of drive (output direction) at which the amount of received light by light receiving unit 401 reaches an inverse peak based on reflection by the low reflection region in a case where an optical axis deviation is not occurring.

However, non-deviation peak storage unit 212 may be configured such that the amount of drive (output direction) at which the amount of received light by light receiving unit 401 reaches a peak based on reflection by the high reflection region in a case where an optical axis deviation is not occurring is stored, while the amount of drive (output direction) at which the amount of received light by light receiving unit 401 reaches an inverse peak based on reflection by the low reflection region in a case where an optical axis deviation is not occurring is not stored, as non-deviation peak information.

When optical axis deviation detecting device 200 employs such a configuration, peak acquisition unit 208 acquires the amount of drive (output direction) at which the amount of received light by light receiving unit 401 reaches a peak. First deviation amount determination unit 214 detects a first optical axis deviation, based on “the amount of drive at the peak” defined by the non-deviation peak information and the acquired “amount of drive (output direction) at the peak”.

Alternatively, non-deviation peak storage unit 212 in the first embodiment may be configured such that the amount of drive (output direction) at which the amount of received light by light receiving unit 401 reaches a peak based on reflection by the high reflection region in a case where an optical axis deviation is not occurring is not stored, while the amount of drive (output direction) at which the amount of received light by light receiving unit 401 reaches an inverse peak based on reflection by the low reflection region in a case where an optical axis deviation is not occurring is stored, as non-deviation peak information.

When optical axis deviation detecting device 200 employs such a configuration, peak acquisition unit 208 acquires the amount of drive (output direction) at which the amount of received light by light receiving unit 401 reaches an inverse peak. First deviation amount determination unit 214 detects a first optical axis deviation, based on “the amount of drive at an inverse peak” defined by the non-deviation peak information and the acquired “amount of drive (output direction) at an inverse peak”.

In an optical axis deviation detecting device employing these configurations, the volume of non-deviation peak information can be reduced, and the volume of calculation in first deviation amount determination unit 214 can be reduced, compared with optical axis deviation detecting device 200 in the present embodiment.

(3) As long as first deviation amount detection unit 210 can detect at least one of a peak and an inverse peak of the amount of received light, the arrangement of the high reflection region and the low reflection region in the adjustment mirror (see FIG. 7 and FIG. 20) may be different from the arrangement described above.

For example, in the adjustment mirror in at least one of FIG. 7 and FIG. 20, the high reflection region may be a low reflection region and the low reflection region may be a high reflection region. In such a case, the peak and the inverse peak are an inverse peak and a peak, respectively, for example, in FIG. 9 and FIG. 10.

(4) Output unit 410 in the present embodiment includes laser output unit 403 and mirror 402. However, output unit 410 may have any configuration that performs driving to change the output direction of output light. For example, output unit 410 may be a laser output unit capable of outputting laser light and driving in the horizontal direction and the vertical direction.

(5) Light from output unit 410 in the present embodiment is used in the target detection process. However, light from output unit 410 may be used for any other applications. Light from output unit 410 may be used, for example, for any other remote sensing techniques, in addition to the target detection process.

Embodiments disclosed here should be understood as being illustrative rather than being limitative in all respects. The scope of the present invention is shown not in the foregoing description but in the claims, and it is intended that all modifications that come within the meaning and range of equivalence to the claims are embraced here.

### REFERENCE SIGNS LIST

200 optical axis deviation detecting device, 202 laser driver, 204 received light amount acquisition unit, 206 mirror driver, 208 peak acquisition unit, 210 first deviation amount detection unit, 212 non-deviation peak storage unit, 214 first deviation amount determination unit, 216 first range storage unit, 220 outer shape information acquisition unit, 222 second deviation amount detection unit, 224 non-deviation outer shape information storage unit, 226 second deviation amount determination unit, 228 second range storage unit, 230 network circuit, 250 first deviation detecting device, 260 second deviation detecting device, 300 camera, 300A front camera, 300B right camera, 300C left camera, 401 light receiving unit, 402 mirror, 405 cover, 410 output unit, 450 drive device, 500 non-deviation outer shape information, 502 right-side mirror.

1. An optical axis deviation detecting device mountable on a movable body, the optical axis deviation detecting device comprising:
an output circuit to perform driving to change an output direction and output light;
a reflective member including a first region and a second region having a lower reflectance of light than the first region, the reflective member reflecting light output from the output circuit;
a light receiver to receive light reflected by the reflective member;
a memory to store beforehand at least one of information on an output direction in which the amount of received light by the light receiver reaches a peak based on reflection by the first region in a case where an optical axis deviation of the output circuit is not occurring and information on an output direction in which the amount of received light by the light receiver reaches an inverse peak based on reflection of light by the second region in a case where an optical axis deviation of the output circuit is not occurring;
an acquisition circuit to acquire information on an output direction when the amount of received light by the light receiver reaches at least one of a peak and an inverse peak by performing driving of the output circuit during detection of the optical axis deviation; and
a detector to detect the optical axis deviation, based on the information on an output direction stored in the memory and the information on an output direction acquired by the acquisition circuit.

2. The optical axis deviation detecting device according to claim 1, wherein
the output circuit
performs driving to change an output direction in a range including a first drive range and a second drive range different from the first drive range, during detection of the optical axis deviation, and
performs driving in the first drive range during driving assistance of the movable body, and
the reflective member is arranged at a position at which light from the output circuit is reflected when the output circuit performs driving in the second drive range.

3. The optical axis deviation detecting device according to claim 1, wherein
the output circuit performs driving in a first direction and a second direction orthogonal to the first direction,
the first region is a first middle region at a midsection along the first direction, the first region excluding a second middle region at a midsection along the second direction, and
the second region is the second middle region and a region excluding the first middle region.

4. The optical axis deviation detecting device according to claim 3, wherein when the optical axis deviation in the first direction is to be detected, the acquisition circuit allows the output circuit to perform driving in the first direction after moving in the second direction.

5. The optical axis deviation detecting device according to claim 3, wherein the reflective member is provided at each of both ends in a drive range in the second direction of the output circuit.

6. The optical axis deviation detecting device according to claim 1, wherein
the acquisition circuit acquires outer shape information indicating a part of an outer shape of the movable body as a result of driving by the output circuit in a predetermined drive range during detection of the optical axis deviation,
the memory stores beforehand outer shape information indicating a part of an outer shape of the movable body acquired by the acquisition circuit as a result of driving by the output circuit in the predetermined drive range in a case where the optical axis deviation is not occurring, and
the detector detects the optical axis deviation, based on the outer shape information stored in the memory and the outer shape information acquired by the acquisition circuit.

7. An optical axis deviation detecting device mountable on a movable body, comprising:
an output circuit to perform driving to change an output direction and output light;
a light receiver to receive light output from the output circuit and reflected by the movable body;
an acquisition circuit to acquire outer shape information indicating a part of an outer shape of the movable body as a result of driving by the output circuit in a predetermined drive range during detection of the optical axis deviation of the output circuit;
a memory to store beforehand outer shape information indicating a part of an outer shape of the movable body acquired as a result of driving by the output circuit in the predetermined drive range in a case where the optical axis deviation is not occurring; and
a detector to detect the optical axis deviation, based on the outer shape information stored in the memory and the outer shape information acquired by the acquisition circuit.

8. The optical axis deviation detecting device according to claim 1, wherein
the acquisition circuit acquires first information on the amount of drive at which the amount of received light by the light receiver reaches at least one of a peak and an inverse peak as a result of driving by the output circuit in a third direction during detection of the optical axis deviation,
the memory stores beforehand first information on the amount of drive at which the amount of received light by the light receiver reaches at least one of a peak and an inverse peak acquired as a result of driving by the output circuit in the third direction in a case where the optical axis deviation is not occurring, and
the detector detects the optical axis deviation, based on the first information on the amount of drive acquired by the acquisition circuit and the first information on the amount of drive stored in the memory.

9. The optical axis deviation detecting device according to claim 8, wherein
the reflective member is provided at each of both ends in a drive range in the third direction of the output circuit, and
the reflective member provided at each of both ends includes one in which the first region and the second region of the reflective member provided at each end are symmetric with respect to a midsection in a drive range in the third direction.

10. The optical axis deviation detecting device according to claim 8, wherein
the acquisition circuit acquires second information on the amount of drive at which the amount of received light by the light receiver reaches at least one of a peak and an inverse peak as a result of driving by the output circuit in the third direction, in a state in which the output circuit is driven by a first amount in a fourth direction different from the third direction, during detection of the optical axis deviation,
the memory stores beforehand second information on the amount of drive at which the amount of received light by the light receiver reaches at least one of a peak and an inverse peak acquired as a result of driving by the output circuit in the third direction, in a state in which the output circuit is driven by a first amount in a fourth direction different from the third direction, in a case where the optical axis deviation is not occurring, and
the detector detects the optical axis deviation, based on the second information stored in the memory and the second information acquired by the acquisition circuit.

11. A target detection device mountable on a movable body,
the target detection device comprising the optical axis deviation detecting device according to claim 1,
wherein the light receiver receives light output from the output circuit and reflected by a target present outside the movable body,
the target detection device further comprising a target detector to detect information on the target, based on the amount of received light by the light receiver.

12. A movable body comprising the target detection device according to claim 11.

13. The optical axis deviation detecting device according to claim 2, wherein
the output circuit performs driving in a first direction and a second direction orthogonal to the first direction,
the first region is a first middle region at a midsection along the first direction, the first region excluding a second middle region at a midsection along the second direction, and
the second region is the second middle region and a region excluding the first middle region.

14. The optical axis deviation detecting device according to claim 4, wherein the reflective member is provided at each of both ends in a drive range in the second direction of the output circuit.

15. The optical axis deviation detecting device according to claim 2, wherein
the acquisition circuit acquires outer shape information indicating a part of an outer shape of the movable body as a result of driving by the output circuit in a predetermined drive range during detection of the optical axis deviation,
the memory stores beforehand outer shape information indicating a part of an outer shape of the movable body acquired by the acquisition circuit as a result of driving by the output circuit in the predetermined drive range in a case where the optical axis deviation is not occurring, and
the detector detects the optical axis deviation, based on the outer shape information stored in the memory and the outer shape information acquired by the acquisition circuit.

16. The optical axis deviation detecting device according to claim 3, wherein
the acquisition circuit acquires outer shape information indicating a part of an outer shape of the movable body as a result of driving by the output circuit in a predetermined drive range during detection of the optical axis deviation,
the memory stores beforehand outer shape information indicating a part of an outer shape of the movable body acquired by the acquisition circuit as a result of driving by the output circuit in the predetermined drive range in a case where the optical axis deviation is not occurring, and
the detector detects the optical axis deviation, based on the outer shape information stored in the memory and the outer shape information acquired by the acquisition circuit.

17. The optical axis deviation detecting device according to claim 2, wherein
the acquisition circuit acquires first information on the amount of drive at which the amount of received light by the light receiver reaches at least one of a peak and an inverse peak as a result of driving by the output circuit in a third direction during detection of the optical axis deviation,
the memory stores beforehand first information on the amount of drive at which the amount of received light by the light receiver reaches at least one of a peak and an inverse peak acquired as a result of driving by the output circuit in the third direction in a case where the optical axis deviation is not occurring, and
the detector detects the optical axis deviation, based on the first information on the amount of drive acquired by the acquisition circuit and the first information on the amount of drive stored in the memory.

18. The optical axis deviation detecting device according to claim 3, wherein
the acquisition circuit acquires first information on the amount of drive at which the amount of received light by the light receiver reaches at least one of a peak and an inverse peak as a result of driving by the output circuit in a third direction during detection of the optical axis deviation,
the memory stores beforehand first information on the amount of drive at which the amount of received light by the light receiver reaches at least one of a peak and an inverse peak acquired as a result of driving by the output circuit in the third direction in a case where the optical axis deviation is not occurring, and
the detector detects the optical axis deviation, based on the first information on the amount of drive acquired by the acquisition circuit and the first information on the amount of drive stored in the memory.

19. The optical axis deviation detecting device according to claim 4, wherein
the acquisition circuit acquires first information on the amount of drive at which the amount of received light by the light receiver reaches at least one of a peak and an inverse peak as a result of driving by the output circuit in a third direction during detection of the optical axis deviation,
the memory stores beforehand first information on the amount of drive at which the amount of received light by the light receiver reaches at least one of a peak and an inverse peak acquired as a result of driving by the output circuit in the third direction in a case where the optical axis deviation is not occurring, and
the detector detects the optical axis deviation, based on the first information on the amount of drive acquired by the acquisition circuit and the first information on the amount of drive stored in the memory.

20. The optical axis deviation detecting device according to claim 7, wherein
the acquisition circuit acquires first information on the amount of drive at which the amount of received light by the light receiver reaches at least one of a peak and an inverse peak as a result of driving by the output circuit in a third direction during detection of the optical axis deviation,
the memory stores beforehand first information on the amount of drive at which the amount of received light by the light receiver reaches at least one of a peak and an inverse peak acquired as a result of driving by the output circuit in the third direction in a case where the optical axis deviation is not occurring, and
the detector detects the optical axis deviation, based on the first information on the amount of drive acquired by the acquisition circuit and the first information on the amount of drive stored in the memory.
